(19) United States
(12) Patent Application Publication
(10) Pub. No.: US 2022/0351577 A1
(43) Pub. Date: Nov. 3, 2022

(54) STAKED VOTING SYSTEM FOR DISTRIBUTED PARI-MUTUEL GAMING

(71) Applicant: dotMM, LLC, Santa Fe, NM (US)

(72) Inventors: Tucker Spaight MOORE, Washington, DC (US); Nathan Douglas MARSHALL, Blackfoot, ID (US)

(21) Appl. No.: 17/728,537

(22) Filed: Apr. 25, 2022

Related U.S. Application Data
(60) Provisional application No. 63/179,698, filed on Apr. 26, 2021.
(60) Provisional application No. 63/326,186, filed on Mar. 31, 2022.

(51) Int. Cl. G07F 17/32; G07C 13/00

(52) U.S. Cl. CPC G07F 17/3262; G07C 13/00; G07F 17/3223; G07F 17/3258

(57) ABSTRACT

Various embodiments include methods and devices for implementing trusted real-world event outcomes on a blockchain. Embodiments may include placing a vote on an outcome of a first pool for a real-world event, in which the vote is linked on the blockchain to an existing action associated with a currency value, determining whether the vote is placed on a majority outcome of the first pool, and determining a currency payout for the vote to a user in response to determining that the vote is placed on the majority outcome of the first pool. Embodiments may include generating a first pool for a real-world event, generating a bet on the first pool, and generating a vote on a second pool, determining a currency payout to a user associated with the vote, and publishing the pool, bet, and vote to the blockchain.

### RELATED APPLICATIONS

This application claims the benefit of priority to U.S. Provisional Patent Application No. 63/179,698 entitled “Trusted Real-world Event Outcomes On A Blockchain: Staked Voting And Its Application To Distributed Gaming” filed Apr. 26, 2021, and the benefit of priority to U.S. Provisional Patent Application No. 63/326,186 entitled “Trusted Real-world Event Outcomes On A Blockchain: Staked Voting And Its Application To Distributed Gaming” filed Mar. 31, 2022, the entire contents of both which are incorporated herein by reference.

### BACKGROUND

Bitcoin became the first widely accepted fully decentralized cryptocurrency. It was the first cryptocurrency to combine blockchain technology with the concept of proof of work to address the problem of double spending. Since then, thousands of other cryptocurrencies have been created. However, as impactful as blockchain technology has been, a challenge that still exists is the ability to bring real-world data onto the blockchain in a reliable and trusted way.

Most blockchains are entirely self-contained, with no mechanism to validate data from the real world. Users can only access data that is reliably created on the blockchain and the “truth” is limited to what the ledger can verify.

### SUMMARY

Various aspects of this disclosure provide methods and apparatuses for implementing such methods of implementing trusted real-world event outcomes on a blockchain, including placing a vote on an outcome of a first pool for a real- world event, in which the vote is linked on the blockchain to an existing action associated with a currency value, determining whether the vote is placed on a majority outcome of at least one majority outcome of the first pool, and determining a currency payout for the vote to a user in response to determining that the vote is placed on the majority outcome of the first pool.

Some aspects may include identifying the majority outcome from a plurality of outcomes of the first pool based on a plurality of votes, including the vote, placed on the plurality of outcomes, in which each of the plurality of votes is linked on the blockchain to an existing action associated with a currency value.

Some aspects may include identifying a bet on a second pool, in which the existing action is an action of the bet and the bet is placed on a majority outcome of at least one majority outcome of the second pool, identifying the user associated with the bet, assigning at least one voting partition of a first plurality of pools for real-world events to the user, in which the first plurality of pools is a subset of a second plurality of pools for real-world events and in which the first plurality of pools includes the first pool, and assigning at least one vote, including the vote, to the user that can be placed on a pool of the first plurality of pools.

Some aspects may include a majority outcome of a second pool as a no-contest outcome in which the existing action is an action of a bet on the second pool, identifying the bet, identifying the user associated with the bet, assigning at least one voting partition of a first plurality of pools for real-world events to the user, in which the first plurality of pools is a subset of a second plurality of pools for real-world events and in which the first plurality of pools includes the first pool, and assigning at least one vote, including the vote, to the user that can be placed on a pool of the first plurality of pools.

In some aspects, the existing action is an action of a bet on a second pool and the bet is a winning bet placed on a majority outcome of at least one majority outcome of the second pool. Some aspects may include in response to determining that the vote is placed on the majority outcome of the first pool, calculating the currency payout for the vote on the first pool based on a plurality of bets made on the second pool, including the bet.

Some aspects may include assigning forfeit currency of at least one bet on the second pool linked on the blockchain to a vote placed against a majority outcome of a third pool for a real-world event to a master user.

In some aspects, the existing action is an action of a bet on a second pool and a majority outcome of the second pool is a no-contest outcome. Some aspects may include assigning the currency amount of the bet on the second pool as the currency payout for the vote on the first pool in response to determining that the vote is placed on the majority outcome of the first pool.

In some aspects, the existing action may include one of a bet on a second pool for a real-world event, a transaction to the user, or a reward to the user as a pool creator user.

Various aspects of this disclosure provide methods, and apparatuses for implementing such methods, of implementing trusted real-world event outcomes on a blockchain, including generating a first pool for a real-world event including a plurality of potential outcomes for the real-world event, generating a bet on the first pool including a first potential outcome of the plurality of potential outcomes, publishing the bet to the blockchain linked to the first pool, generating a vote on a second pool for a real-world event including a second potential outcome of a plurality of potential outcomes included on the second pool, publishing the vote to the blockchain linked to the bet, and determining a currency payout based at least in part on a currency amount of the bet to a user associated with the vote.

In some aspects, generating the vote on the second pool may include generating the vote on the second pool in response to the first potential outcome being a majority outcome of at least one majority outcome of the first pool.

In some aspects, generating the vote on the second pool may include generating the vote on the second pool in response to a majority outcome of the first pool being a non-contest outcome.

In some aspects, determining the currency payout may include determining the currency payout in response to the second potential outcome being a majority outcome of at least one majority outcome of the second pool.

Some aspects may include assigning a currency fee to a pool creator user associated with the first pool in response to at least one of the plurality of potential outcomes for the real-world event being at least one majority outcome of the first pool.

Some aspects may include assigning a currency reward to a pool creator user associated with the first pool in response to at least one of the plurality of potential outcomes for the real-world event being at least one majority outcome of the first pool.

Some aspects may include assigning currency associated with the vote to a master user in response to all majority outcomes of the second pool being at least one potential outcome of the plurality of potential outcomes included on the second pool other than the second potential outcome.

In some aspects, the plurality of potential outcomes for the event include at least one non-binary outcome.

Further aspects include a computing device including a processing device configured to perform operations of any of the methods summarized above. Further aspects include a non-transitory processor-readable storage medium having stored thereon processor-executable software instructions configured to cause a processor to perform operations of any of the methods summarized above.

### BRIEF DESCRIPTION OF THE DRAWINGS

The accompanying drawings, which are incorporated herein and constitute part of this specification, illustrate example embodiments of various embodiments, and together with the general description given above and the detailed description given below, serve to explain the features of the claims.

FIG. 1 is a component block diagram illustrating an example computing network suitable for implementing various embodiments.

FIGS. 2A and 2B are component block diagrams illustrating example computing systems for implementing various embodiments.

FIG. 3 is a process flow diagram illustrating a method for implementing trusted real-world event outcomes on a blockchain according to an embodiment.

FIG. 4 is a process flow diagram illustrating a method for placing bet(s) on a pool of the blockchain according to an embodiment.

FIG. 5 is a process flow diagram illustrating a method for placing votes on the pool of the blockchain according to an embodiment.

FIG. 6 is a process flow diagram illustrating a method for determining an outcome of the pool of the blockchain according to an embodiment.

FIGS. 7A and 7B are process flow diagrams illustrating methods for assigning a vote(s) to a user(s) of a bet(s) on the pool of the blockchain according to an embodiment.

FIGS. 8A, 8B, and 8C are process flow diagrams illustrating methods for determining a payout(s) for bet(s) on another pool(s) of the blockchain according to an embodiment.

FIGS. 9A and 9B are interaction flow diagrams illustrating examples of implementing trusted real-world event outcomes on a blockchain according to various embodiments.

FIGS. 10A-10E are pseudo code diagrams illustrating examples of implementing validation for trusted real-world event outcomes on a blockchain according to an embodiment.

FIG. 11 is a component block diagram illustrating an example mobile computing device suitable for implementing various embodiments.

FIG. 12 is a component block diagram illustrating an example mobile computing device suitable for implementing various embodiments.

FIG. 13 is a component block diagram illustrating an example server suitable for implementing various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments include methods, and computing devices implementing such methods of implementing trusted real-world event outcomes on a distributed ledger, such as a blockchain. Embodiments may include a distributed oracle implementing a staked voting system for a decentralized platform on which real-world event outcomes may be determined. Various embodiments and examples are described herein in a gambling context for ease of explanation and clarity; however, the gambling context examples are not intended to limit the scope of the claims and description to this context. One of skill in the art would realize that the technology disclosed herein may be applied in various other contexts, such as contexts in which the veracity of information relating to events outside of the distributed ledger are crucial to the integrity of transactions or other actions recorded on the distributed ledger.

The term “computing device” is used herein to refer to stationary computing devices including personal computers, desktop computers, all-in-one computers, workstations, super computers, mainframe computers, embedded computers (such as embedded in other larger systems), servers, multimedia computers, and game consoles. The terms “computing device” and “mobile computing device” are used interchangeably herein to refer to any one or all of cellular telephones, smartphones, personal or mobile multi-media players, personal data assistants (PDA's), laptop computers, tablet computers, convertible laptops/tablets (2-in-1 computers), smartbooks, ultrabooks, netbooks, palm-top computers, multimedia Internet enabled cellular telephones, mobile gaming consoles, and similar personal electronic devices that include a memory, and a programmable processor.

The terms “distributed ledger” and “blockchain” are used interchangeably herein to refer to any type of distributed ledger, including a blockchain, that may be shared and synchronized over a network of multiple entities or users. The distributed ledger may document and preserve the history of objects, such as cryptocurrency, by storing all previous transactions and may be used to validate all future transactions. The distributed ledger may maintain consistency across the network by cryptographically linking blocks of transactions. This linkage may ensure integrity of each block. If a block were changed, or if a transaction within a block were changed, a hash of that block also may change. Therefore, all subsequent blocks may need to change as well in order to remain valid.

The terms “majority outcome of a pool” or “majority outcome” are used herein to refer to one or more outcomes of a pool on which votes have been cast and which have accumulated: a highest number of votes compared to each other outcome of the pool; an equal number of votes to one or more other outcomes of the pool and a higher number of votes to the remaining outcomes of the pool; or an equal number of votes to all other outcomes of the pool. In some embodiments, the accumulated votes of the majority outcome(s) may be less than or equal to 50% of all votes cast on the pool.

Various embodiments are described in terms of code, e.g., processor-executable instructions, for ease and clarity of explanation, but may be similarly applicable to any data, e.g., code, program data, or other information stored in memory. The terms “code”, “data”, and “information” are used interchangeably herein and are not intended to limit the scope of the claims and descriptions to the types of code, data, or information used as examples in describing various embodiments.

A digital currency is a currency without a physical form and is only transferrable electronically. Traditional digital currencies are centrally issued and regulated by banks or, in some cases, by privately owned companies. A cryptocurrency, however, is a type of digital currency that is typically decentralized, requiring no central regulating entity. Decentralized cryptocurrencies use cryptography and a public ledger system to ensure honesty among users. Decentralization allows distributed security across its users and faster settlement of payment.

Due to a growing distrust in the press and other centralized institutions, there is a growing need to bring real-world data into a blockchain in a reliable and robust way. However, most decentralized blockchains are entirely self-contained and do not provide users with the ability to validate the outcome of real-world events. Users can only access data that is reliably created on the blockchain and the “truth” is limited to what the ledger can verify. Thus, a challenge that still exists is the ability to bring real-world data onto the blockchain in a reliable and trusted way.

In previous attempts to address this problem, blockchains have utilized oracles. There are many different types of oracles, but they all serve the same purpose—to transfer data between the real world and the closed-world system of the blockchain. However, a significant challenge in incorporating oracles on a blockchain, especially a decentralized blockchain, is maintaining trust across its users. There must be an incentive in place for each oracle to act honestly. While there are several oracle platforms, the current state of the art has significant deficiencies: (i) there are major limitations on supported event types; (ii) reporting algorithms are susceptible to attacks; and (iii) the existing platforms exhibit varying degrees of centralization.

The embodiments herein address and solve the foregoing problems by implementing a novel staked voting algorithm and a unique pari-mutuel design in a distributed protocol that satisfies the following: (i) no centralized point of failure; (ii) events with any number of outcomes supported with the same level of trust; and (iii) resistance to expected attacks such as Sybil attacks, collusion, denial of service, and hash manipulation.

The embodiments herein support the use of actions. In some embodiments, the actions may represent pools, bets, votes, and/or transactions. In some embodiments, the actions may contain elements that may each represent a pool, a bet, a vote, and/or a transaction. Users may interact with the network by creating pools representing real-world events, placing bets on those pools, casting votes on pool outcomes, and transacting with other users. These actions may allow users to interact with each other, and the protocol designed around them, including the novel method of staked voting and unique pari-mutuel design, creating a fully distributed, self-handicapping, gambling network that may allow non-binary real-world event outcomes to be determined in a reliable and trusted way. The non-binary event outcomes may be determined with the same level of trust as binary event outcomes while defending against attacks that existing oracle networks are subject to, including Sybil attacks, collusion, and denial of service.

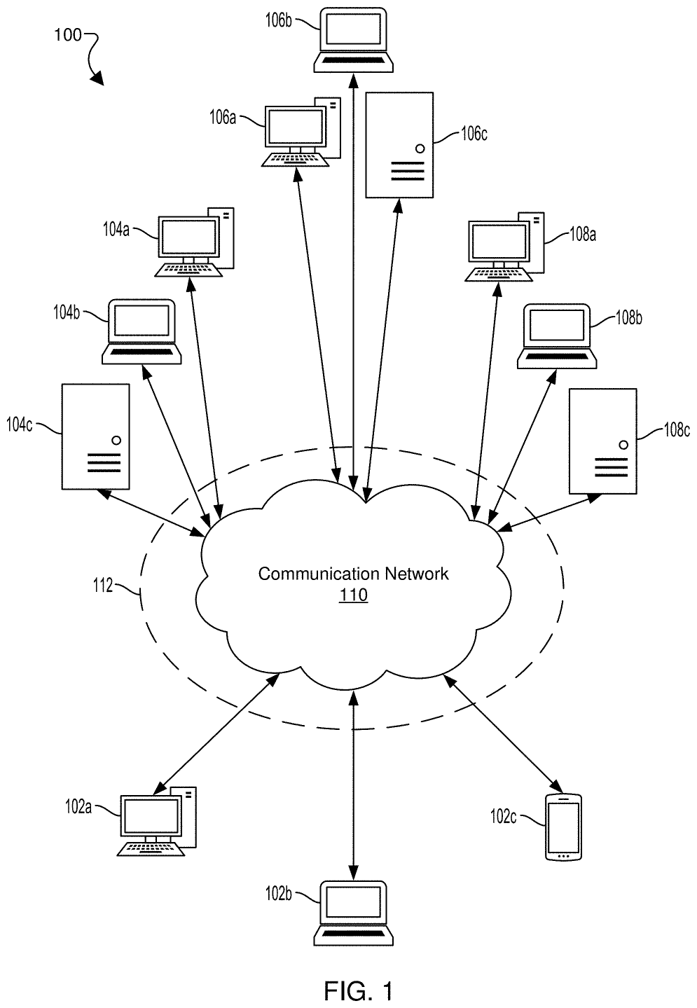

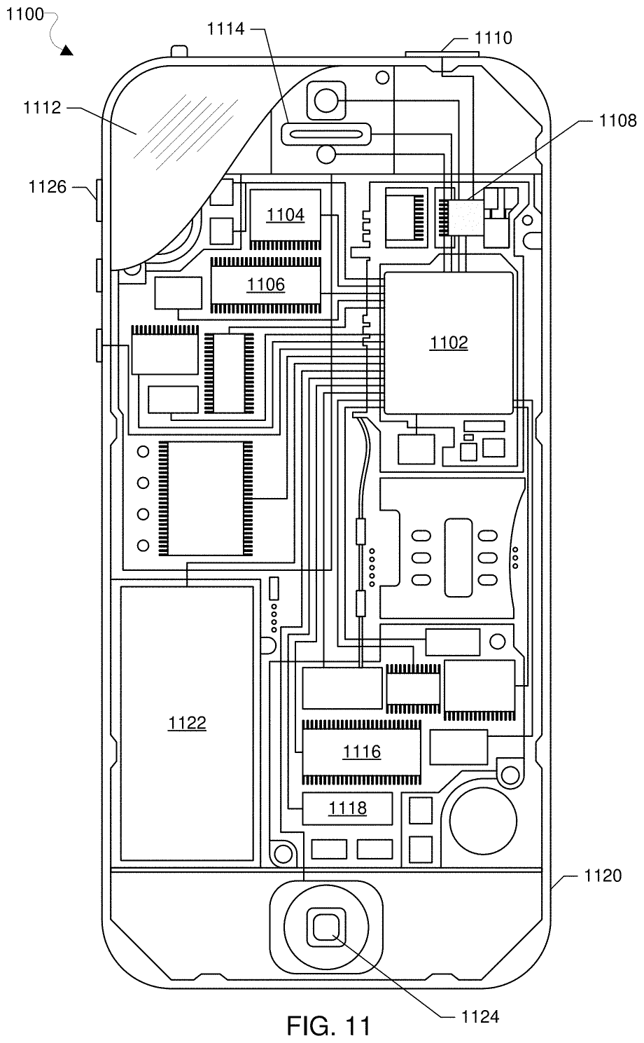

FIG. 1 illustrates an example computing network 100 suitable for implementing various embodiments. With reference to FIG. 1, the computing network 100 may be configured to implement a distributed ledger system, and may include any number and combination of computing devices 102a, 102b, 102c, 104a, 104b, 104c, 106a, 106b, 106c, 108a, 108b, 108c, communicatively connected via a communication network 110. A distributed ledger implemented by the distributed ledger system may include multiple instances of linked data, such as verified and linked blocks, stored across multiple of the computing devices 102a-102c, 104a-104c, 106a-106c, 108a-108c. Examples of the computing devices 102a-102c, 104a-104c, 106a-106c, 108a-108c are described further herein, such as computing devices 1100, 1200, 1300 described with reference to FIGS. 11-13, respectively.

In the example illustrated in FIG. 1, simple nodes (or lite nodes) may include the computing devices 102a-102c, and may initiate (or “publish”) new actions on the distributed ledger. An action that a simple node may initiate, as described further herein, may include, a pool for a real-world event, a bet on the pool, a vote on the pool, and/or a transaction between users. Mining nodes may include the computing devices 104a-104c. A mining node may construct (or mine) data of validated actions to help build the distributed ledger. Full nodes may include the computing devices 106a-106c. A full node may validate new actions and data, as well as disseminate those actions and data across the computing network 100. Oracles may include the computing devices 108a-108c. An oracle may be an entity enabled to transfer data between the real world and the distributed ledger through placement of a vote on a pool. In some embodiments, any of computing devices 102a-102c, 104a-104c, 106a-106c, 108a-108c, may be implemented as one or a combination of a simple node, a mining node, a full node, and/or an oracle.

Any number and combination of the computing devices 102a-102c, 104a-104c, 106a-106c, 108a-108c may transmit and receive data from any number and combination of the computing devices 102a-102c, 104a-104c, 106a-106c, 108a-108c via the communication network 110 using wired and/or wireless communication connections, which are collectively referred to as communication connections 112 in FIG. 1. The communication network 110 may include any combination of communication network components configured for wired and/or wireless communication between the computing devices 102a-102c, 104a-104c, 106a-106c, 108a-108c and the communication network 110 to implement communication between the computing devices 102a-102c, 104a-104c, 106a-106c, 108a-108c. For example, the communication network components may include transmission media (e.g., twisted-pair wire, coaxial cable, optical fiber cable, etc.), modems, routers, switches, hubs, repeaters, bridges, gateways, base stations, servers, etc. The communication network 106 may be configured for communication using any number and combination of communication protocols, such as internet protocols (IP), transmission control protocols (TCP), user datagram protocols (UDP), web service protocols (WS), routing protocols, wireless communication protocols, mobile communication protocols, etc. The communication network 110 may be any combination of interconnected communication networks, such as local area networks (LAN), wide area networks (WAN), wireless mobile communication networks, the Internet, etc.

The simple nodes, the computing devices 102a-102c, may initiate new actions on the distributed ledger. In some embodiments, to publish an action, a user may first sign a hash of a previous action along with an address (unique identifier assigned to a user) of the new owner and then broadcast that data to the network through its neighboring full nodes. In some embodiments, to publish an action, a user may first sign a payload of an action, including a list of reference identifiers (IDs) referencing previously validated and published elements, and then broadcast that data to the network through its neighboring full nodes.

The mining nodes, the computing devices 104a-104c, may construct data of validated actions to help build the distributed ledger. A mining node may form blocks of new validated actions and perform a proofing process, such as proof of work, proof of stake, proof of history, etc. In response to the mining node having satisfied a proofing requirement, the mining node may publish the blocks to the distributed ledger by broadcasting the blocks to the computing network 100 through its neighboring full nodes.

The full nodes, the computing devices 106a-106c, may validate new actions and blocks, as well as disseminate those actions and blocks across the computing network 100. Validating actions and blocks may maintain the integrity of the distributed ledger by ensuring users do not spend currency they do not have or publish blocks without first performing the required proof of work. Most cryptocurrencies built on decentralized networks use a “gossip protocol” to disseminate data based on the way rumors are spread. A full node may send data to its neighboring full nodes. Each of those full nodes may then send the data to their own neighboring full nodes, and so on. A neighboring full node may be a full node with which another node can communicate freely. In response to a full node receiving data that it has already received, the transmission may stop.

The oracles, the computing devices 108a-108c, may be entities enabled to transfer data between the real world and the distributed ledger through placement of a vote on a pool. An oracle may include a software, hardware, and/or a human user of the computing device 108a-108c. Software and/or hardware of the oracle may enable a human user of the oracle to place a vote on a pool to transfer data between the real world and the distributed ledger using the computing device 108a-108c.

Some or all of the computing devices 102a-102c, 104a-104c, 106a-106c, 108a-108c may be arranged differently and/or combined while still supporting the functions of various embodiments. The computing devices 102a-102c, 104a-104c, 106a-106c, 108a-108c may not be limited to the number of computing devices 102a-102c, 104a-104c, 106a-106c, 108a-108c illustrated in FIG. 1.

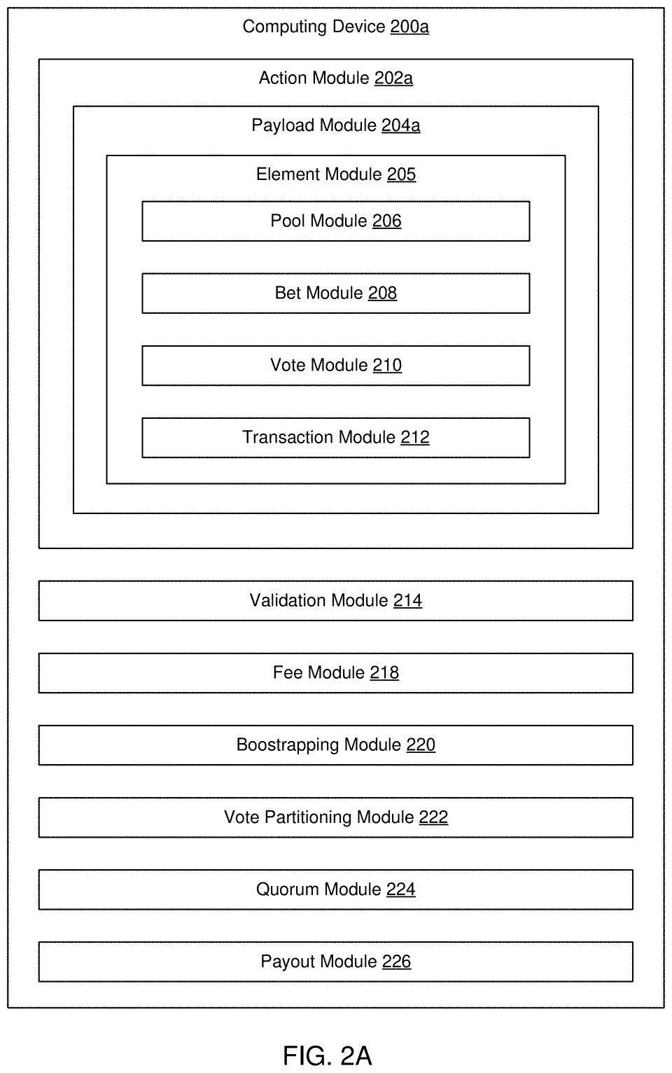

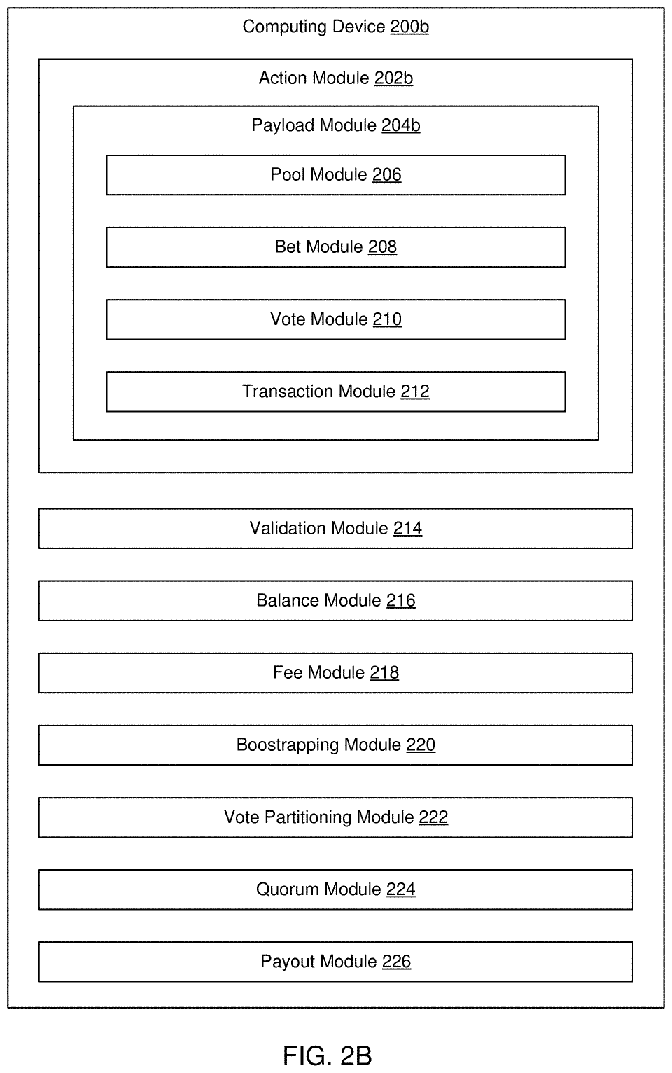

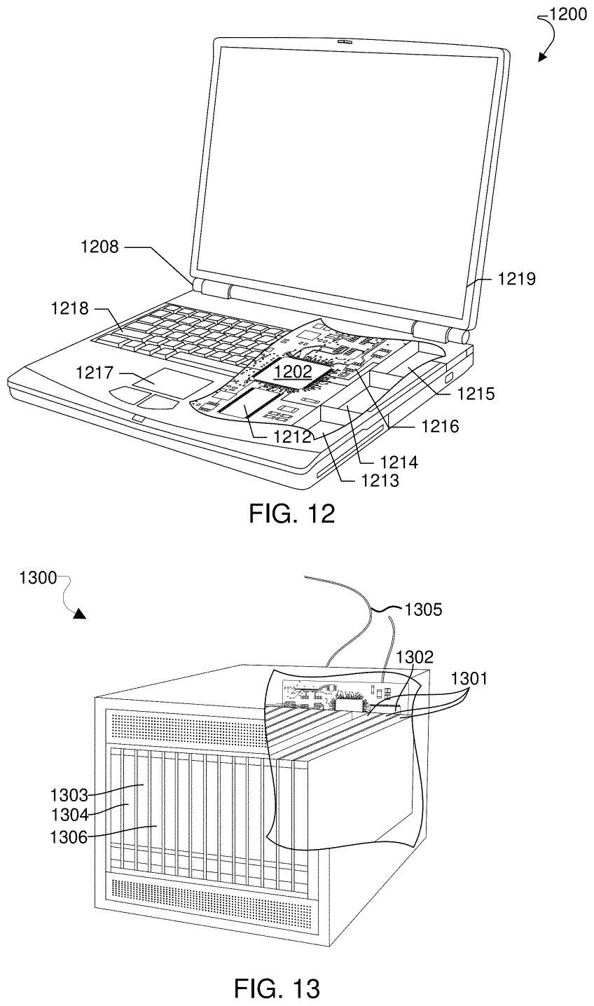

FIGS. 2A and 2B illustrate examples of computing systems for implementing various embodiments. With reference to FIGS. 1-2B, a computing device 200a, 200b (e.g., computing device 104a-104c, 106a-106c, 108a-108c in FIG. 1) may include any number and combination of modules 202a, 202b, 204a, 204b, 205, 206, 208, 210, 212, 214, 216, 218, 220, 222, 224, 226 configured for implementing trusted real-world event outcomes on a blockchain. The modules 202-226 may be any combination of hardware module and/or software module executable on a processor (e.g., processor 1102 in FIG. 11, processor 1202 in FIG. 12, processor 1301 in FIG. 13) and stored on a memory (e.g., memory 1106 in FIG. 11, 1212, 1213 in FIG. 12, memory 1302, 1304 in FIG. 13) of the computing device 200.

With reference to FIG. 2A, an action module 202a may be configured to generate the actions and publish the actions to the blockchain. Actions may be used to interact with the blockchain and may include one or more elements representing pools, bets, votes, and/or transactions. Each action may include a header and a payload. The header may contain fields, including an action identifier (ID) field and a signature field. The action ID field may contain a unique action ID, an identifier of the action, and may be created by hashing data of the payload, such as by an Ed25519 signing algorithm. The action ID may be used by other actions for validation, as described further herein. The signature field may contain a signature of the payload generated by a user's private key, for example, by an SHA-256 hash. The payload may include one or more reference IDs referencing one or more published elements on the blockchain, referred to herein as input elements, and one or more new elements to be published to the blockchain, referred to herein as output elements. Actions may be referred to herein by an output element of the action, for example, a pool type action or a pool action. Example components of an action are illustrated in the following table:

| Field Name | Data Type | Field Size | Description |
|---|---|---|---|
| action ID | byte[32] | 32 | Unique identifier of the action |
| signature | byte[64] | 64 | The signature of the payload |
| payload | payload | variable | Input and output elements |

A payload module 204a may be configured to generate the payloads of the actions. A payload of an action may contain fields, including, a public key field, an address field, an inputs field, an outputs field, and a data field. The action type field may include data specific to the action type. The public key field may include a public key, such as an Ed25519 public key, provided by the user to validate the signature. The address field may include an address that may be a unique identifier for the user and may be generated by hashing the public key. The inputs field may include one or more reference IDs referencing previously validated and published elements and may be used to validate the action, as discussed further herein. For example, a reference ID may correspond to a previously validated and published element in which this user received enough coins to cover the outgoing coins of the action. For another example, a reference ID may correspond to a previously won bet in which the user received enough votes to cover the outgoing votes of the action. The data field may include unvalidated data provided by the user. Example components of a payload are illustrated in the following tables:

| Field Name | Data Type | Field Size | Description |
|---|---|---|---|
| public key | byte[32] | 32 | User's public key |
| address | byte[32] | 32 | Unique user identifier |
| inputs | byte[64][?] | variable | Reference ID(s) referencing |
| | | | previously validated and |
| | | | published elements |
| outputs | element[?] | variable | Unvalidated element(s) to be |
| | | | published to the blockchain |
| data | byte[32] | 32 | Unvalidated data provided by |
| | | | the user |

An element module 205 may be configured to generate an element for inclusion in the payload of the actions. An element may contain fields, including an element type field, and a nonce field. The element type field may include data specifying the element type. The element type may denote whether the element is a pool, bet, vote, and/or transaction. The nonce field may include random data in order to distinguish an element from other elements in this same action. Example components of an element are illustrated in the following tables:

| Field Name | Data Type | Field Size | Description |
|---|---|---|---|
| element type | byte | 1 | Denotes the type of element |
| nonce | byte[32] | 32 | Random nonce generated by |
| | | | the user |

Element Type

| Description | Value |
|---|---|
| Pool | 0x01 |
| Bet | 0x02 |
| Vote | 0x03 |
| Transaction | 0x04 |

A pool module 206 may be configured to generate the pool type elements, referred to herein as pools. A pool may be an element based on an event occurring outside of the blockchain, such as a real-world event, for which potential outcomes may be provided by an entity interacting with the blockchain, such as a user via a computing device (e.g., computing device 102a-102c in FIG. 1). A pool may contain fields, including a title field, a description field, an outcomes field, and an expiration time field. The title field may include a title of a pool's event (e.g., “2018 World Cup Final”). In some embodiments, the title may be a set of characters, such as, up to 64 characters. The description field may include a description of the pool (e.g., “This pool represents the 2018 World Cup Final between France and Croatia played on 15 Jul. 2018.”). In some embodiments, the description may be a set of characters, such as, up to 256 characters. The outcomes field may include potential outcomes of the event on which bettors may place bets. Each outcome may be a set of characters, such as a string, representing a specific outcome (e.g., [“France Wins”, “Croatia Wins”, “Match Canceled”]). In some embodiments, the outcomes may be a set of characters, such as, up to 64 characters. The expiration time field may include an expiration time, such as a Unix time, at which the pool closes to new bets and starts accepting votes. Example components of a pool are illustrated in the following table:

| Field Name | Data Type | Field Size | Description |
|---|---|---|---|
| title | var_str(64) | variable | Title of pool |
| description | var_str(256) | variable | Description of pool |
| outcomes | var_str(64) | variable | List of potential outcomes |
| expiration time | int | 8 | Expiration time |

A bet module 208 may be configured to generate the bet type elements, referred to herein as bets. A bet may be a wager of currency placed on a potential outcome of the pool by an entity interacting with the blockchain, such as a user via a computing device (e.g., computing device 102a-102c in FIG. 1). A bet may contain fields, including a pool ID field, an outcome field, and an amount field. The pool ID field may include a pool ID that may be the action ID/element ID pair associated with the pool on which this bet is placed. The pool ID may be generated by a hash of the pool data. The outcome field may include an outcome represented as value, such as an integer, corresponding to an index of the outcome in the pool's outcomes field on which the bet is placed. The amount field may be an amount of currency wagered on the bet. Example components of a bet are illustrated in the following table:

| Field Name | Data Type | Field Size | Description |
|---|---|---|---|
| pool ID | byte[64] | 64 | The pool ID on which this |
| | | | bet is placed |
| outcome | int | 8 | The chosen outcome |
| amount | int | 8 | Amount to wager |

A vote module 210 may be configured to generate the vote type element, referred to herein as votes. A vote may be a vote for a potential outcome of the pool by an entity interacting with the blockchain, such as a user via a computing device (e.g., computing device 102a-102c in FIG. 1), and the vote may correspond to an actual outcome of the event. In other words, the potential outcome of the pool on which the vote may be placed may correspond to the actual outcome of the event. However, it is possible that a vote is placed on a potential outcome of the pool that does not correspond to the actual outcome of the event. A vote may contain fields, including a pool ID field, a partition key field, an outcome field, and an amount field. The pool ID field may include the pool ID that may be the action ID/element ID pair associated with the pool on which this vote is placed. The partition key field may include a partition key associated with votes of a transaction. The outcome field may include an outcome represented as a value, such as an integer, corresponding to an index of the outcome in the pool's outcomes field on which this vote is placed. The amount field may include a number of votes to be contributed in the vote element. Example components of a vote are illustrated in the following table:

| Field Name | Data Type | Field Size | Description |
|---|---|---|---|
| pool ID | byte[64] | 64 | The pool ID on which this vote |
| | | | is being placed |
| partition key | byte[32] | 32 | The partition key associated |
| | | | with votes |
| outcome | int | 8 | The chosen outcome |
| amount | int | 8 | The number of votes being |
| | | | contributed |

A transaction module 212 may be configured to generate the transaction type element, referred to herein as transactions. A transaction may be a transfer of currency to a user on the computing network (e.g., computing network 100 in FIG. 1). For example, a transaction may be a transfer of coins and/or votes between users. A transaction may contain fields, including a transaction type field, a recipient address field, an amount field, and a partition key field. The transaction type field may denote whether a transaction is transferring coins or votes. The recipient address field may include a recipient address that may be the address associated with the user to which the transaction is being sent. The amount field may include an amount of currency, such as coins and/or votes, being sent as part of the transaction. The partition key field may include a partition key associated with votes of a transaction. The partition key field may be unused (e.g., empty, null value, etc.) for a transaction sending coins. Example components of a transaction are illustrated in the following table:

| Field Name | Data Type | Field Size | Description |
|---|---|---|---|
| transaction type | byte | 1 | Type of currency (coins or |
| | | | votes) |
| recipient address | byte[32] | 32 | Address of recipient |
| amount | int | 8 | Amount to send |
| partition key | byte[32] | 32 | Partition key associated |
| | | | with votes. |
| | | | Unused for coins. |

Transaction Type

| Description | Value |
|---|---|
| Coin | 0x01 |
| Vote | 0x02 |

A validation module 214 may be configured to validate actions and blocks published to the block chain. Validation may maintain a consistent and trusted blockchain between otherwise trustless users. Validation may ensure that users do not spend coins they do not own, place bets on closed pools, or nefariously vote on pools. Full nodes (e.g., computing devices 106a-106c in FIG. 1) may be responsible for validation. Validation may be implemented based on the reference IDs referencing previously validated and published elements that a user may reference in order to provide either proof of coins or proof of votes for an action. Proof of coins may be required when generating any action that requires currency, such as creating a pool, placing a bet, or making a transaction. Proof of votes may be required when placing a vote.

To provide proof of coins, reference IDs may refer to votes or transactions. These reference IDs may provide coins as input from input elements to a new action, meeting or exceeding the number of coins being consumed by the output elements of the action. For example, if a user wishes to place a bet for 10 coins, that user may provide reference IDs of input elements in which they received at least 10 coins. A user may reference the vote ID of a vote placed on a majority outcome of a pool as, thereby redeeming winnings from a previously won bet. A user may reference the transaction ID of a transaction in which they were sent currency from another user. To provide proof of votes, reference IDs may refer to previously won bets, previously created pools, or previously received transactions in which the user received votes.

The validation module 214 may validate an action published to the blockchain. To validate an action, the validation module 214 may implement one or more validation criteria operations. For example, validation of an action may include validating the action ID, the public key, the signature, and the input reference ID(s). Validation of an action may also include validating the number of input coins referenced by the input reference ID(s) meets or exceeds the number of coins being consumed by the output element(s). Validation of an action may also include validating the number of input votes per partition key referenced by the input reference ID(s) meets or exceeds the number of votes being consumed per partition key by the output element(s).

The validation module 214 may validate a pool as an input element to an action. The validation module 214 may validate that the input pool has not been referenced in another action, that the input pool was authored by the same address authoring this action, that the input pool has closed, that the input pool has resolved (e.g., been voted on to resolution of at least one majority outcome), and/or that the input pool has not resolved in “no contest.”

The validation module 214 may validate a pool as an output element to an action. The validation module 214 may validate that the output pool's title does not exceed the maximum length, that the output pool's description does not exceed the maximum length, that the output pool's list of outcomes includes at least one outcome, and/or that each outcome in the output pool's potential outcomes does not exceed the maximum length.

The validation module 214 may validate a bet as an input element to an action. The validation module 214 may validate that the input bet has not been referenced in another action, that the input bet was authored by the same address authoring this action, that the pool on which the input bet was placed has closed, that the pool on which an input bet was placed has resolved, and/or that the input bet was a winning bet.

The validation module 214 may validate a bet as an output element to an action. The validation module 214 may validate that the pool on which the output bet was placed exists in the blockchain and that the timestamp of the block in which the bet is included is no later than the expiration time of the pool on which the bet is being placed.

The validation module 214 may validate a vote as an input element to an action. The validation module 214 may validate that the input vote has not been referenced in another action, that the input vote was authored by the same address authoring this action, that the pool on which the input vote was placed has resolved, and that the input vote was placed on the majority outcome of the pool.

The validation module 214 may validate a vote as an output element to an action. The validation module 214 may validate that the pool on which the output vote was placed exists on the blockchain, that the pool on which the output vote was placed has closed, and that the pool on which the output vote was placed has not yet reached a quorum.

The validation module 214 may validate a transaction as an input element to an action. The validation module 214 may validate that the input transaction has not been referenced in another action and that the input transaction was sent to the same address authoring the action.

The validation module 214 may validate a transaction as an output element to an action. The validation module 214 may validate that the transaction type is valid. If the transaction type is a coin transaction, the user may send the transaction to any user on the network. If the transaction type is a vote transaction, the user may send the transaction to themselves, or the transaction may be a mining transaction.

With reference to FIG. 2B, an action module 202b may be configured to generate actions and publish the actions to the blockchain. Actions may be used to interact with the blockchain and may represent pools, bets, votes, and/or transactions. Each action may include a header and a payload. The header may contain fields, including an action identifier (ID) field and a signature field. The action ID field may contain a unique action ID, an identifier of the action, and may be created by hashing data of the payload, such as by an SHA-256 hash. The action ID may be used by other actions for validation, as described further herein. The action ID may be referred to as a pool ID, bet ID, vote ID, or transaction ID, depending on a specific action type. The signature field may contain a signature of the payload generated by a user's private key, for example, by an Ed25519 signing algorithm. The payload may be a base class representing either a pool, bet, vote, or transaction. Actions may be referred to herein by a type of payload of the action, for example, a pool type action or a pool action. Example components of an action are illustrated in the following table:

| Field Name | Data Type | Field Size | Description |
|---|---|---|---|
| action ID | byte[32] | 32 | Unique identifier of the action |
| signature | byte[64] | 64 | The signature of the payload |
| payload | payload | variable | Pool/Bet/Vote/Transaction |

A payload module 204b may be configured to generate the payloads of the actions. A payload of an action may contain fields, including an action type field, a public key field, an address field, a reference ID field, and a timestamp field. The action type field may include data specific to the action type. The action type may denote whether the action is a pool, bet, vote, or transaction. The public key field may include a public key, such as an Ed25519 public key, provided by the user to validate the signature. The address field may include an address that may be a unique identifier for the user and may be generated by hashing the public key. The reference ID field may include a reference ID that may be an action ID of a previously validated and published action and may be used to validate the action, as discussed further herein. For example, if the action represented a pool, bet, or transaction, the reference ID may correspond to a previous action in which this user received enough currency to cover the cost of the action. For another example, if the action represented a vote, the reference ID may correspond to a previously won bet. The timestamp field may include a timestamp, such as a Unix time, of the time when the action is created. Example components of a payload are illustrated in the following tables:

| Field Name | Data Type | Field Size | Description |
|---|---|---|---|
| action type | byte | 1 | Denotes the type of Action |
| public key | byte[32] | 32 | User's public key |
| address | byte[32] | 32 | Unique user identifier |
| reference ID | byte[32] | 32 | Reference action ID |
| timestamp | int | 8 | Timestamp of action creation |
| data | byte[32] | 32 | Payload data |

Action Type

| Description | Value |
|---|---|
| Pool | 0x01 |
| Bet | 0x02 |
| Vote | 0x03 |
| Transaction | 0x04 |

The pool module 206 may be configured to generate the pool type actions, referred to herein as pools. A pool may be an action based on an event occurring outside of the blockchain, such as a real-world event, for which potential outcomes may be provided by an entity interacting with the blockchain, such as a user via a computing device (e.g., computing device 102a-102c in FIG. 1). A pool may contain fields, including a title field, a description field, an outcomes field, and an expiration time field. The title field may include a title of a pool's event (e.g., “2018 World Cup Final”). In some embodiments, the title may be a set of characters, such as, up to 64 characters. The description field may include a description of the pool (e.g., “This pool represents the 2018 World Cup Final between France and Croatia played on 15 Jul. 2018.”). In some embodiments, the description may be a set of characters, such as, up to 256 characters. The outcomes field may include potential outcomes of the event on which bettors may place bets. Each outcome may be a set of characters, such as a string, representing a specific outcome (e.g., [“France Wins”, “Croatia Wins”, “Match Canceled”]). In some embodiments, the outcomes may be a set of characters, such as, up to 64 characters. The expiration time field may include an expiration time, such as a Unix time, at which the pool closes to new bets and starts accepting votes. Example components of a pool are illustrated in the following table:

| Field Name | Data Type | Field Size | Description |
|---|---|---|---|
| title | var_str(64) | variable | Title of pool |
| description | var_str(256) | variable | Description of pool |
| outcomes | var_str(64) | variable | List of potential outcomes |
| expiration time | int | 8 | Expiration time |

The bet module 208 may be configured to generate the bet type actions, referred to herein as bets. A bet may be a wager of currency placed on a potential outcome of the pool by an entity interacting with the blockchain, such as a user via a computing device (e.g., computing device 102a-102c in FIG. 1). A bet may contain fields, including a pool ID field, an outcome field, and an amount field. The pool ID field may include a pool ID that may be the action ID associated with the pool on which this bet is placed. The pool ID may be generated by a hash of the pool data. The outcome field may include an outcome represented as value, such as an integer, corresponding to an index of the outcome in the pool's outcomes field on which the bet is placed. The amount field may be an amount of currency wagered on the bet. Example components of a bet are illustrated in the following table:

| Field Name | Data Type | Field Size | Description |
|---|---|---|---|
| pool ID | byte[32] | 32 | The pool ID on which this |
| | | | bet is placed |
| outcome | int | 8 | The chosen outcome |
| amount | int | 8 | Amount to wager |

The vote module 210 may be configured to generate the vote type actions, referred to herein as votes. A vote may be a vote for a potential outcome of the pool by an entity interacting with the blockchain, such as a user via a computing device (e.g., computing device 102a-102c in FIG. 1), and the vote may correspond to an actual outcome of the event. In other words, the potential outcome of the pool on which the vote may be placed may correspond to the actual outcome of the event. However, it is possible that a vote is placed on a potential outcome of the pool that does not correspond to the actual outcome of the event. A vote may contain fields, including a pool ID field and an outcome field. The pool ID field may include the pool ID that may be the action ID associated with the pool on which this vote is placed. The outcome field may include an outcome represented as a value, such as an integer, corresponding to an index of the outcome in the pool's outcomes field on which this vote is placed. Example components of a vote are illustrated in the following table:

| Field Name | Data Type | Field Size | Description |
|---|---|---|---|
| pool id | byte[32] | 32 | The pool ID on which this vote |
| | | | is being placed |
| outcome | int | 8 | The chosen outcome |

The transaction module 212 may be configured to generate the transaction type actions, referred to herein as transactions. A transaction may be a transfer of currency to a user on the computing network (e.g., computing network 100 in FIG. 1). A transaction may contain fields, including a recipient address field and an amount field. The recipient address field may include a recipient address that may be the address associated with the user to which the transaction is being sent. The amount field may include an amount of currency being sent as part of the transaction. Example components of a transaction are illustrated in the following table:

| Field Name | Data Type | Field Size | Description |
|---|---|---|---|
| recipient address | byte[32] | 32 | Address of recipient |
| amount | int | 8 | Amount to send |

The validation module 214 may be configured to validate actions and blocks published to the block chain. Validation may maintain a consistent and trusted blockchain between otherwise trustless users. Validation may ensure that users do not spend coins they do not own, place bets on closed pools, or nefariously vote on pools without having previously won a bet. Full nodes (e.g., computing devices 106a-106c in FIG. 1) may be responsible for validation. Validation may be implemented based on reference IDs, which may be the unique action ID of a previously validated action that a user may reference in order to provide either proof of funds or proof of bet for an action. Proof of funds may be required when generating any action that requires currency, such as creating a pool, placing a bet, or making a transaction. Proof of bet may be required when placing a vote, as the user may have first previously won a bet in order to vote on a pool.

To provide proof of funds, reference IDs may refer to pools, votes, or transactions. These action IDs may hold balances used to ensure users are not placing a bet or sending a transaction that exceeds their current balance. For example, if a user wishes to place a bet for 10 coins, that user may provide a reference ID of an action in which they received at least 10 coins. A user may reference the pool ID of a pool which they created, having received a reward for creating that pool. A user may reference the vote ID of a vote, thereby redeeming winnings from a previously won bet. A user may reference the transaction ID of a transaction in which they were sent currency from another user. To provide proof of bet, reference IDs may refer to previously won bets.

The validation module 214 may validate an action published to the blockchain. To validate an action, the validation module 214 may implement one or more validation criteria operations. For example, validation of an action may include validating the action ID, the public key, the signature, the reference ID of the previous action, and the timestamp.

The validation module 214 may validate a pool by additionally validating that a current balance of the action, corresponding to the reference ID provided in the pool, is no smaller than a fee (e.g., 1 coin) associated with creating the pool.

The validation module 214 may validate a bet by additionally validating that: the pool on which the bet is placed, corresponding to the pool ID provided in the bet, exists in the blockchain; the timestamp of the bet is no later than the expiration time of the pool on which the bet is being placed; and the current balance of the action, corresponding to the reference ID provided in the bet, is no smaller than the size of the bet.

The validation module 214 may validate a vote by additionally validating that the pool on which the vote is placed, corresponding to the pool ID provided in the vote, exists on the blockchain, has not yet reached a quorum, and belongs to the correct voting partition. To validate the vote the validation module 214 may also validate that the bet, corresponding to the reference ID provided in the vote, exists on the blockchain, was authored by the same address associated with the vote, is a winning bet, and has not been referenced in another vote.

The validation module 214 may validate a transaction by additionally validating that a current balance of the action, corresponding to the reference ID provided in this transaction, is no smaller than the size of the transaction.

The actions may hold balances of currency and provide proof of funds. A balance module 216 may calculate the balances of the actions. Such balances may include one or more of fees for one or more actions, such as a fee for creating a pool, and/or amounts of currency for one or more actions, such as amounts of a bet and/or a transaction. A balance of an action may be a calculation using the balance of one or more of the actions. For example, to calculate the current balance of an action, the balance module 216 steps through the blockchain calculating the total cost of each action referencing the action and subtracting that cost from the action's initial balance.

An initial balance of an action may be calculated by the balance module 216 based on the action type. The initial balance of a pool may depend on the outcome of the pool. If the outcome selected by a majority vote is an outcome identified in the pool's potential outcomes, the pool's creator may be awarded a portion, such as one percent, of the total pot. The initial balance of the pool may be the portion awarded to the pool creator of all bets placed on that pool. If the majority outcome is a “no-contest,” where the pool's outcome is not provided in the potential outcomes, the pool's creator may receive no reward, and the initial balance of a “no-contest” pool may be zero.

An initial balance of a vote may be calculated by the balance module 216 depending on the outcome of the vote. If the user votes with the majority, the vote's initial balance may be equal to the winnings of the previously won bet referenced in the vote. If the user votes against the consensus, the initial balance of the vote may be zero; thus, winnings from the previously won bet may be forfeited. In some embodiments, the forfeited amount may be distributed among the winning bet users who vote with the consensus. In some embodiments, the forfeited amount may be distributed to a master address, or master user.

An initial balance of a transaction may be calculated by the balance module 216 depending on the amount of the transaction sent to a user.

With reference to FIGS. 2A and 2B, the computing network (e.g., computing network 100 in FIG. 1) may implement a custom blockchain, giving a creator of the blockchain autonomy to manage fees, rather than having to abide by fee structures of other blockchains. For example, the fees of the blockchain may be in amounts to maintain the network and ensure the integrity of system operation. A fee module 218 may manage the fees charged for interacting with the blockchain.

A fee may be charged by the fee module 218 to any user to create a pool. For example, the fee may be a dynamic fee, such as a fee calculated every 100 blocks based on a distribution of pool sizes, to publish a pool to the blockchain. For another example, the fee may be a static fee, such as a fee of one coin, to publish a pool to the blockchain. The fee may be intended to dissuade nefarious users from spamming the computing network with bogus pools. In some embodiments, the fee may contribute directly to an accumulated amount of currency of the pool, such as from fees and bets, referred to herein as a pot of the pool. In some embodiments, the fee may be collected by the master address. However, to reward users for creating pools and to encourage creation of popular and competitive pools, once the pool closes, if the consensus outcome was one provided in the potential outcomes, the pool's creator may be awarded the portion of the total bets placed on that pool.

A fee may be charged by the fee module 218 to place a bet. For example, there may be a one percent fee on all bets. This fee may be used to reward the pool's creator and may be the only fee that bettors will be required to pay. If a pool ends in a “no-contest”, bettors may be returned their full bet amount including the one percent fee. Because fees in casinos and other centralized gambling applications can be as high as ten percent, a lower fee, such as the one percent fee paid out to pool creators may be attractive to users.

The computing network may be dependent on a cycle of winning bettors voting on outcomes of other pools. Accordingly, there may be a systemic “gap” as to an initial pool. For the initial pool created, and the bets placed on the initial pool, there may be no previous set of bet winners to vote on the outcome. To address this issue, the bootstrapping module 220 may generate and publish a genesis block, the first block on the blockchain that may be used to validate all future actions. Additionally, the genesis block may be used to bootstrap the computing network, using initial investors' addresses and the master address. The genesis block may not be validated in the same manner as subsequent blocks, rather the genesis block may be accepted as truth.

In some embodiments, the genesis block may contain two sets of actions. First, the genesis block may contain a coin transaction from the master address to investors' addresses, for example, in an amount of 50 percent of the investors' initial investments. Second, the genesis block may contain a vote transaction from the master address to the investors' addresses, for example, in an amount of 50 percent of the investors' initial investments.

In some embodiments, the genesis block may contain four sets of actions. First, the genesis block may contain a transaction from the master address to the investors' addresses, for example, in an amount of 50 percent of the investors' initial investments. Second, the genesis block may contain a pool, the genesis pool, created by the master address with a single outcome. Third, the genesis block may contain bets on the genesis pool that the master address may make on behalf of the investors using a remaining amount, such as 50 percent, of an investor's initial investment. Each investor may sign their bet when they invest in the computing network. Fourth, the genesis block may contain a vote from the master address (deemed sufficient to form a quorum only in the genesis block) on the pool's single outcome.

When the genesis block is published to the blockchain, the computing network may be fully “bootstrapped.” In some embodiments, if a user wishes to create a pool, place a bet, or execute a transaction, that user may reference the action ID/element ID pair of the initial coin transaction originating from the master address in the genesis block. If a user wishes to vote on a pool, the user may reference the action ID/element ID pair of the initial vote transaction originating from the master address in the genesis block. In some embodiments, if a user wishes to create a pool, place a bet, or execute a transaction, that user may reference the action ID of the initial transaction originating from the master address in the genesis block. And if a user wishes to vote on a pool, the user may reference their winning genesis bet allowing the user to redeem the remaining portion, such as 50 percent, of their initial investment.

Initial investment made by investors may not make up the entirety of the economy of the computing network. The genesis block and initial investment may be used to bootstrap the process and cycle of betting and voting. New users wishing to participate may be able to earn currency, including coins and/or votes, by mining new blocks of actions or by purchasing currency from a cryptocurrency exchange.

In order for users to redeem their winnings from a winning bet, the user may vote with a consensus on a pool. Each vote and pool may be assigned an approximately random voting partition by a vote partition module 222 with a requirement that votes may be placed on pools within their voting partition. The voting partition may be a subset of the pools on the computing network and limit the placement of votes to the pools of the voting partition. Limiting votes to voting partitions may aid in randomizing pool assignments to the user and defending against a Sybil attack. In some embodiments, the voting partition may allow the number of pools on which a user can vote to be proportional to their bet amount—the smaller a user's bet, the fewer pools the user may vote on—defending against an attacker placing a large number of small bets in the hopes of then placing a large number of dishonest votes on a particular pool.

The vote partition module 222 may determine the voting partition. In some embodiments, the vote partition module 222 may determine the voting partition by the leading n bits of a vote or pool's partition key. In other words, a vote and pool may belong to the same partition if the first n bits of their partition keys match. The value of n may be dynamic and recalculated, such as every 100 blocks such that, on average, each partition may contain at least 3 pools.

$$n = ⌊ {log}_{2} ( \frac{♯ of closed pools}{3} ) ⌋$$

Since votes can be generated in many ways, a vote's partition key may be calculated accordingly. In some embodiments, a vote may be generated from a previously placed bet, and the partition key may be computed as hash(bet_{id}⊕block_{id}), where bet_{id} may be the ID of the previously placed bet and block_{id} may be the ID of the block in which the bet was placed. In some embodiments, a vote may be generated from a pool creator user's pool, and the partition key may be computed as hash(pool_{id}⊕block_{id}), where pool_{id} may be the ID of the pool itself, and block_{id} may be the ID of the block in which the pool was created. In some embodiments, a vote may be generated as part of a mining reward, and the partition key may be computed as hash(prevBlock_{id}) where prevBlock_{id d}may be the ID of a parent block to the block that the miner mined.

Similarly, a pool's partition key may be computed as hash(pool_{id}⊕block_{id}), where pool_{id} may be the ID of the pool itself, and block_{id} may be the ID of the block in which the pool closed. Including block_{id} in the computation of a pool's partition key may ensure the pool's partition key cannot be determined until after the pool closes. This may prevent an attacker from knowing in which partition an open pool will fall and potentially placing a large bet on that pool, knowing they could vote on it later.

Approximate random pool assignment may be generated across voters. A block_{id} may be generated by hashing serialized block data with an approximately random nonce in order to meet specific proof of work requirements, resulting in an approximately random block_{id}. Each partition key may be generated by hashing either a bet_{id} or pool_{id} XORed with an approximately random block_{id}, resulting in an approximately random partition key.

In some embodiments, the vote partition module 222 may determine the voting partition by the leading n bits of a pool ID and voter value. For example, if n=1, there may be two partitions, those pools whose pool IDs begin with the bit 0 and those that begin with the bit 1. If n=2, there may be four partitions, and so on. Using this design, the number of partitions may be equal to 2ⁿ.

The following equation based on the size of the voter's winning bet may be used to determine the value of n. As the size of the bet decreases, n increases.

n=max(1, 10−log₂(betₐₘₒᵤₙₜ))

The user's voting value, V, may be used by the vote partition module 222 to determine the voting partition in which a user can vote. The first n bits of the voting value may equal the first n bits of the pool ID of the pool the user may vote on. Below are embodiments in which the vote partition module 222 may calculate a voting value.

V=bet_{id}

In some embodiments, the user's voting value may be set equal to the user's bet ID. This embodiment may be susceptible to a hash manipulation attack. Because the bet ID is the hash of a user's bet, a user may have the ability to alter their timestamp by small enough amounts to not be considered invalid, but to manipulate their bet ID in order to force the leading n bits to equal a wanted sequence. In this way, the user may be able to vote on whichever pool or in whichever partition. To defend against this attack, we may introduce more randomness.

V=bet_{id}⊕vote_{id1}⊕ . . . ⊕vote_{idn}

In other embodiments, the user's voting value may be set equal to the user's bet ID XORed with all vote IDs on the user's pool. Because these vote IDs are essentially random to the bettor at the time the user places a bet, the user may not be able to manipulate their bet ID in a way to target a specific pool. However, this embodiment may still be susceptible to a hash manipulation attack in a different way. Because vote_{id1}⊕ . . . ⊕vote_{idn} may not change for a given pool, that value may be considered constant. Therefore, a user could place many small bets on a pool and manipulate their bet IDs such that the leading n bits were all equal, regardless of what the specific sequence was. In this way, when the user's bet IDs are XORed with the vote IDs, although the user could not force the leading n bits to equal a specific sequence, the user could force the leading n bits to all be equal. Therefore, while the user may not be able to target a specific partition with this design, the user may still be able to target a partition.

V=hash(bet_{id}⊕vote_{id}⊕ . . . ⊕vote_{idn})

In other embodiments, to defend against both of these attacks the user's voting value may be set equal to a hash of the user's bet ID XORed with all vote IDs on the user's pool. In a similar manner as the pool ID is used to assign a voting partition to a pool, the voter value may be used to assign a voting partition to a voter. In other words, the vote partition module 222 may determine the voting partition by the leading n bits of the user's voting value.

A quorum may be used to determine when voting on a pool is closed and payouts can be made. A quorum may be achieved when a criterion is met for the number of votes placed on the pool. A quorum module 224 may determine the criteria for the quorum and when the quorum is reached. How the quorum is defined may be crucial in ensuring the computing network runs smoothly and efficiently. If the quorum is too small, there may be a bottleneck of bet winners waiting to vote. If the quorum is too large, there may not be enough winning bettors to satisfy the quorum requirement and pools may fail to complete in a timely manner.

In some embodiments, to prevent a scenario from occurring where there is a surplus of unresolved bets or a surplus of unplaced votes, there may be on average an equal number of coins and votes in circulation at any one time. Accordingly, a pool may produce as many coins as it consumes as well as produce as many votes as it consumes. Otherwise, overtime, there may either be a surplus of coins or a surplus of votes. To achieve this balance, the quorum module 224 may set the quorum of a pool equal to the number of votes that pool will generate. Because winning bets are paid out in votes (one vote for each coin won), a pool may generate as many votes as the total pot. Therefore, a pool's quorum may equal the total pot. As a result, as more coins are bet on a pool, more votes will be produced. And as more votes are placed on a pool, more coins will be produced.

In some embodiments, the quorum module 224 may prevent excessive voting on a pool by any user. The quorum module 224 may implement a vote capping threshold to limit the number of votes cast on a pool by any user. For example, the threshold may be 20% of the number of votes to achieve a quorum.

In some embodiments, at any given time, the total quorum across all closed pools may equal, on average, the number of voters, or winning bettors. Additionally, the quorum may grow as the computing network's user base grows. As the number of pools and bets increases, the size of the required quorum may also increase.

In some embodiments, on average, an outcome of a given pool may have

$$\frac{\vert bets \vert}{\vert outcomes \vert}$$

bets placed on it, where |bets| is the number of bets placed on a pool and |outcomes| is the number of potential outcomes of the pool. Therefore, the expected number of winning bettors from a given pool may be approximately the same, because there is only one winning outcome. To ensure the total quorum across all pools does not diverge from the number of winning bettors, the quorum for a given pool to be:

$$Quorum = \frac{\vert bets \vert}{\vert outcomes \vert}$$

In some embodiments, a payout module 226 may determine winnings of a bet by the ratio of total losing bets to total winning bets minus a fee, such as one percent to reward the pool's creator. Let W be the winnings from a bet, b be the amount of the bet, bₗ be the set of all losing bets on that pool, and b_{w} be the set of all winning bets on that pool:

$$W = 0.99 \cdot b \cdot ( 1 + \frac{\sum {b}_{l}}{\sum {b}_{w}} )$$

As discussed herein, winnings may be distributed to users associated with winning bets once the user has voted with the consensus on another pool. However, when a user votes against the consensus of another pool, the user may forfeit the winning of the winning bet. In some embodiments, amounts that a user forfeits may be changed from an instance of the set of all winning bets on that pool to an instance of the set of all the losing bets on the pool. In some embodiments, amounts that a user forfeits may be removed as an instance of the set of all winning bets on that pool and transferred to the master address.

In some embodiments, a payout module 226 may determine winnings of a bet by calculating a total pot of a pool where B is the set of all bets placed on that pool.

$$pot = Pool Creator User Fee + {\sum }_{j ∈ B} {bet}_{j}$$

The pool creator user fee may be a fee charged to a user for publishing a pool to the blockchain. The pool creator user fee may contribute entirely to the pot and help prime the pool for betting. The fee may prevent nefarious users from spamming the network with bogus pools.

The pool creator user fee may be large enough to prevent users from attempting to attack the computing network, but small enough that with the pool creator reward, pool creators may profit, incentivizing them to create and publish good pools. The pool creator fee may be dynamic. As the price of currency increases and decreases over time, the pool creator fee may reflect the changes. Therefore, the pool creator fee may be the following, where “recent” represents a last 100 blocks: 0.01*(a percentile of pot sizes across recent pools, such as between approximately a 10^{th} to a 50^{th} percentile). As such, whether the price of currency rises or falls, the expected profit for a pool creator user may remain constant.

Using the calculated pot, winnings from bet, where W c B is the set of all winning bets placed on the pool.

$${winnings}_{i} = ⌊ 0.99 * pot * \frac{b e {t}_{i}}{{\sum }_{j ∈ W} {bet}_{j}} ⌋$$

The winnings may be rounded down to the nearest integer and the fractional remainder, the “dust,” may be collected and added to the pool creator user's reward, which may be a portion of the pot of the pool, such as one percent. This may be computed as follows, to avoid rounding errors.

$$Pool Creator User ' s Reward = pot - {\sum }_{j ∈ W} {winnings}_{j}$$

The computing network may implement a pari-mutuel betting system, in which the odds may change as more bets are placed. As can be seen in the calculations of the payouts, the payouts may be dependent on the pot and the set of all winning bets placed on the pool. Therefore, the odds determining the payouts may change with changes in the pot and the number of bets placed on the pool.

Some or all of the modules 202a-226 may be arranged differently and/or combined or separated while still supporting the functions of various embodiments. The modules 202a-226 may not be limited to the number and arrangement of modules 202a-226 illustrated in FIG. 2. For example, some of the modules 202a-226 may be located on separate computing devices 200, rather than a single computing device 200 illustrated in FIG. 2. Such as action module 202a, 202b and the validation module 214 may be located at different computing devices 200a, 200b. References made to particular field names, data types, variable sizes, and field sizes are for illustrative purposes, and are not intended to limit the scope of the claims and description. One of skill in the art would realize that the variations on field names, data types, variable sizes, and field sizes may be used to implement the various embodiments described herein. In the examples, herein use of a “?” denotes a size or type of data, variable, or field that is variable.

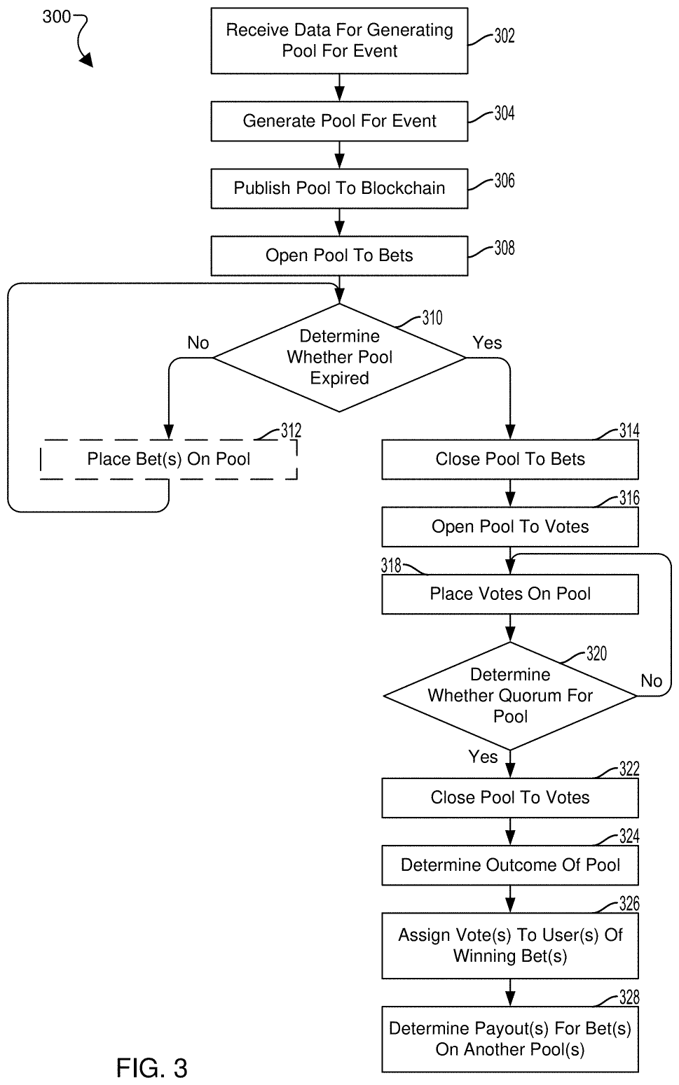

FIGS. 3-8C illustrate methods 300, 400, 500, 600, 700, 800a, 800b, 800c for implementing trusted real-world event outcomes on a blockchain according to various embodiments. With reference to FIGS. 1-8C, each of the methods 300, 400, 500, 600, 700, 800a, 800b, 800c may be implemented in a computing device (e.g., computing device 104a-104c, 106a-106c, 108a-108c in FIG. 1, computing device 200a, 200b in FIGS. 2A and 2B) in hardware (e.g., modules 202a-226 in FIGS. 2A and 2B), in software (e.g., modules 202a-226 in FIGS. 2A and 2B) executing on a processor (e.g., processor 1102 in FIG. 11, processor 1202 in FIG. 12, processor 1301 in FIG. 13), or in a combination of software-configured processor and dedicated hardware that includes other individual components, such as various memories/caches (e.g., memory 1106 in FIG. 11, 1212, 1213 in FIG. 12, memory 1302, 1304 in FIG. 13) and various memory/cache controllers. In order to encompass the alternative configurations enabled in various embodiments, the hardware implementing the methods 300, 400, 500, 600, 700, 800a, 800b, 800c is referred to herein as a “processing device.”

FIG. 3 illustrates a method 300 for implementing trusted real-world event outcomes on a blockchain according to an embodiment. In block 302, the processing device may receive data for generating a pool for an event. Any user of the computing network (e.g., computing network 100 in FIG. 1) may send data for generating a pool via a computing device, and that data may be received by the processing device. The data may include a title, description, list of potential outcomes for the event, and an expiration time for bets. The title and description may be used to provide information to the bettors as to what event the pool represents. The list of potential outcomes may include potential outcomes for the event on which users can place bets. The expiration time may be used to set a deadline at which the pool stops accepting new bets and starts accepting votes. Other data relating to the user, such as account data including the user's address and public key, and type of action or type of element the user is requesting, such as a pool, may be received by the processing device. This other data may be received from the software used by the user to enter data and request the action, and/or from data repositories on other computing devices of the computing network that may be queried in response to the user's provision of the data.

In block 304, the processing device may generate a pool for the event. The processing device may generate a pool type action, using the data received in block 302 to populate and to generate other data to populate fields of the pool type action. In some embodiments, the processing device may generate the pool type action having a pool type element discussed herein with reference to FIG. 2A. For example, the fields may be the fields of an action, a payload, an element, and a pool. Such fields of an action may include an action ID, a signature of the user, and a payload. Such fields of a payload may include a public key of the user, an address of the user, an input reference ID(s), an output reference ID(s), and payload data. Such fields of an element may include an element type and a nonce. Such fields of a pool may include a title for the pool, a description for the pool, potential outcomes for the pool, and an expiration time for the pool. In some embodiments, the processing device may generate the pool type action having a pool type payload discussed herein with reference to FIG. 2B. For example, the fields may be the fields of an action, a payload, and a pool. Such fields of an action may include an action ID, a signature of the user, and a payload. Such fields of a payload may include an action type, a public key of the user, an address of the user, a reference ID, a time stamp, and payload data. Such fields of a pool may include a title for the pool, a description for the pool, potential outcomes for the pool, and an expiration time for the pool. The processing device may also generate a pool ID for the pool, for example, from hashing the pool's data for either the pool type element or the pool type action. The pool ID may be used by other actions to reference the pool, for example, when placing bets and/or votes on the pool.

In block 306, the processing device may publish the pool to the blockchain. The processing device may broadcast the pool to the computing network and the pool may be stored on multiple computing devices. To publish the pool, the computing devices receiving the pool may validate the data of the pool, as described further herein with reference to FIGS. 2A and 2B. The current example assumes that validation of the pool is successful. Otherwise, publication of the pool to the blockchain may fail. The data of the pool type action may link the pool to another action existing on the blockchain. For example, the pool may be linked to the genesis block or a previous action of the user. For example, the reference ID may be an ID of a previous action of the user, such as a vote by the user or a transaction to the user, which represents sufficient currency to cover the cost of publishing the pool.

In block 308, the processing device may open the pool to bets. In some embodiments, the pool may be published to the blockchain in a manner that is open to accepting bets. In other words, there may be no restriction on when bets may start to be placed on the pool. In some embodiments, other mechanisms may be implemented to control when a pool may be opened for bets. For example, a criterion may be met before allowing bets to be placed on the pool, such as time delay from the publishing of the pool, a critical mass of validated copies of the pool on the blockchain, etc.

In determination block 310, the processing device may determine whether the pool is expired. The pool data may include an expiration time for the pool. The processing device may compare the expiration time for the pool to a reference time, such as a system time of the processing device or external time source, to determine whether the reference time exceeds the expiration time for the pool.

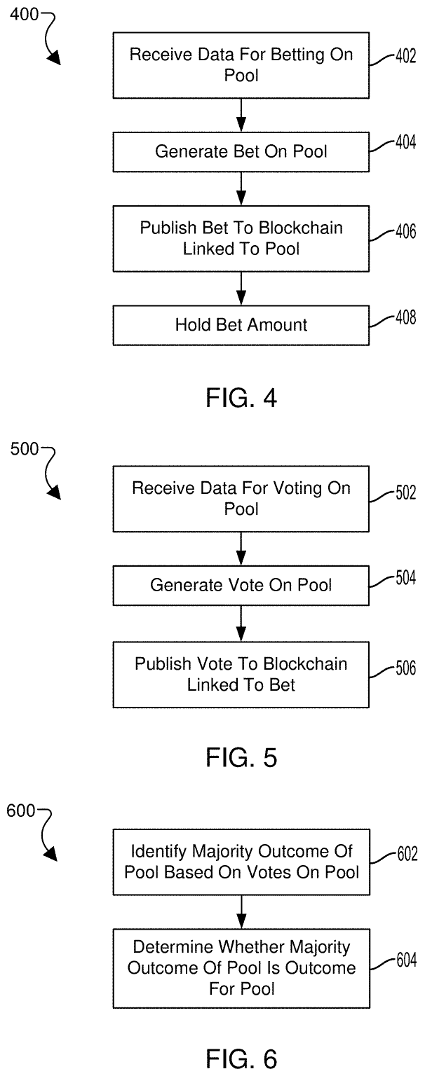

In response to determining that the pool is not expired (i.e., determination block 310=“No”), the processing device may place bets on the pool in optional block 312. Placing bets on the pool is described further herein for the method 400 with reference to FIG. 4. Placing bets may be optional, for example, based on whether any bets are received.

In response to determining that the pool is expired (i.e., determination block 310=“Yes”), the processing device may close the pool to bets on the pool in block 314. In some embodiments, to close the pool to bets the processing device may prevent generating a bet type action referencing the pool ID of the pool closed to bets. In some embodiments, to close the pool to bets the processing device may ignore, reject, fail to validate, etc. a bet referencing the pool ID of the pool closed to bets.

In block 316, the processing device may open the pool to votes. In some embodiments, to open the pool to votes the processing device may allow generating a vote type action referencing the pool ID of the pool open to votes. In some embodiments, to open the pool to votes the processing device may accept and/or validate a vote referencing the pool ID of the pool open to votes.

In block 318, the processing device may place votes on the pool. Placing votes on the pool is described further herein for the method 500 with reference to FIG. 5.

In determination block 320, the processing device may determine whether a quorum of votes for the pool is achieved. The processing device may compare the number of votes on the pool to the criteria for the quorum. In response to the pool receiving a number of votes to achieve the criteria for the quorum, the processing device may determine that the quorum of votes for the pool is achieved. Otherwise, the processing device may determine that the quorum of votes for the pool is not achieved.

In response to determining that the quorum of votes for the pool is not achieved (i.e., determination block 320=“No”), the processing device may continue to place votes on the pool block 318.

In response to determining that the quorum of votes for the pool is achieved (i.e., determination block 320=“Yes”), the processing device may close the pool to votes in block 322. In some embodiments, to close the pool to votes the processing device may prevent generating a vote type action referencing the pool ID of the pool closed to votes. In some embodiments, to close the pool to votes the processing device may ignore, reject, fail to validate, etc. a vote referencing the pool ID of the pool closed to votes.

In block 324, the processing device may determine the outcome of the pool. The outcome of the pool may be one or more outcomes of the pool receiving the most votes. The one or more outcomes of the pool may be winning outcomes based on a majority vote on one or more potential outcomes of the pool or a “no-contest” outcome based on a majority vote on an outcome not part of the potential outcomes of the pool. Determining the outcome of the pool is further described herein for the method 600 with reference to FIG. 6.

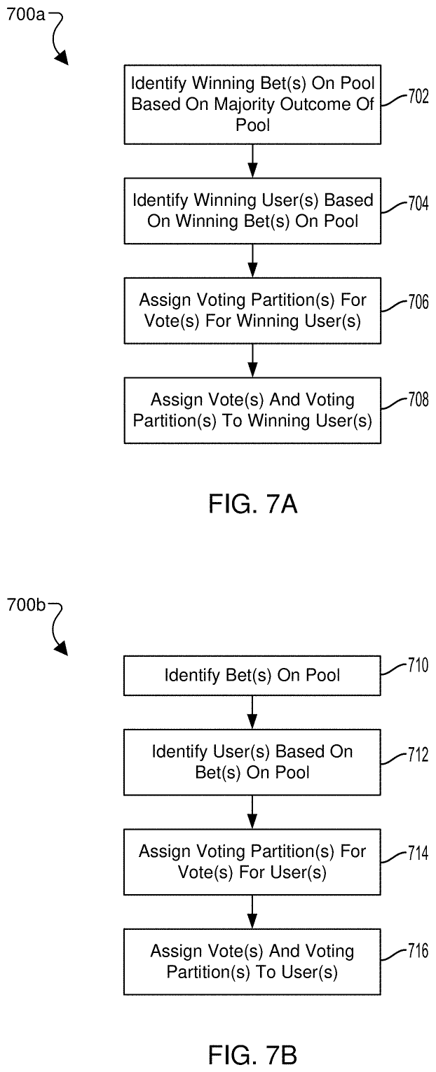

In block 326, the processing device may assign a vote(s) to a user(s) of a bet(s). The processing device may determine whether a bet is a winning bet or a bet on the pool with a “no-contest” result based on the one or more outcomes of the pool determined in block 324, and assign a vote(s) to a user associated with the winning bet or to all users with bets on the pool with a “no-contest” result. Assigning the vote(s) to the user(s) of the winning bet(s) is further described herein for the method 700 a with reference to FIG. 7A. Assigning the vote(s) to the user(s) of the bet(s) on the pool with a “no-contest” result is further described herein for the method 700b with reference to FIG. 7B.

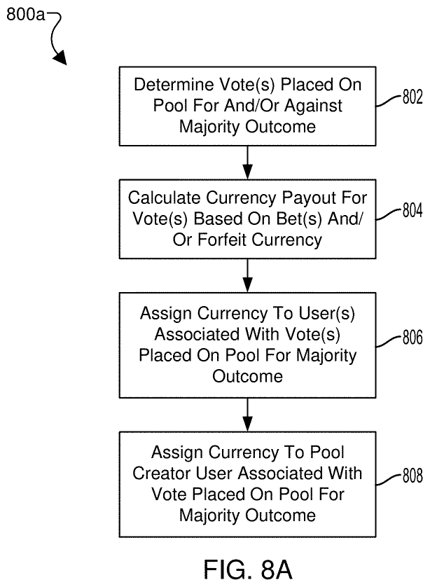

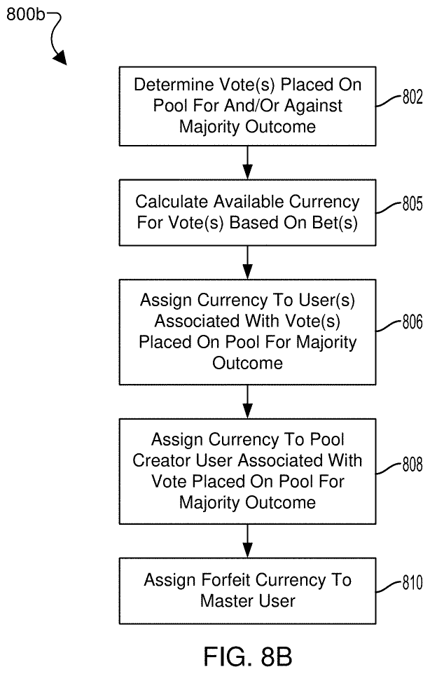

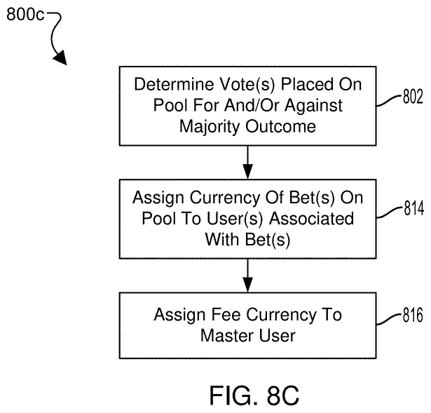

In block 328, the processing device may determine a payout(s) for a bet(s) on another pool(s). A payout for a winning bet on another pool may be held until the user associated with the winning bet votes with the majority on the one or more outcomes of the pool. Determining the payout(s) for the bet(s) on the other pool(s) is further described herein for the methods 800a, 800b, 800c with reference to FIGS. 8A, 8B, 8C respectively.

FIG. 4 illustrates a method 400 for placing bet(s) on a pool of the blockchain according to an embodiment. The method 400 may further describe embodiments of optional block 312 of the method 300 described herein with reference to FIG. 3. In block 402, the processing device may receive data for betting on the pool. Any user of the computing network (e.g., computing network 100 in FIG. 1) may send data for betting on the pool via a computing device, and that data may be received by the processing device. The data may include a pool ID, outcome, and amount. In some embodiments, the pool ID may be the action ID and element ID pair associated with the pool on which the bet may be placed. In some embodiments, the pool ID may be the action ID associated with the pool on which the bet may be placed. The outcome may be a value, such as an integer, corresponding to an index of the outcome in the pool's potential outcomes on which the bet may be placed. The amount may be an amount of currency, such as a number of coins, wagered on the bet. Other data relating to the user, such as account data including the user's address and public key, and type of action or type of element the user is requesting, such as a bet, may be received by the processing device. This other data may be received from the software used by the user to enter data and request the action, and/or from data repositories on other computing devices of the computing network that may be queried in response to the user's provision of the data.

In block 404, the processing device may generate a bet on the pool. The processing device may generate a bet type action, using the data received in block 402 to populate and to generate other data to populate fields of the bet type action. In some embodiments, the processing device may generate the bet type action having a bet type element discussed herein with reference to FIG. 2A. For example, the fields may be the fields of an action, a payload, an element, and a bet. Such fields of an action may include an action ID, a signature of the user, and a payload. Such fields of a payload may include a public key of the user, an address of the user, an input reference ID(s), an output reference ID(s), and payload data. Such fields of an element may include an element type and a nonce. Such fields of a bet may include a pool ID, an outcome of the potential outcomes of the pool, and a bet amount. In some embodiments, the processing device may generate the bet type action having a bet type payload discussed herein with reference to FIG. 2B. For example, the fields may be the fields of an action, a payload, and a bet. Such fields of an action may include an action ID, a signature of the user, and a payload. Such fields of a payload may include an action type, a public key of the user, an address of the user, a reference ID, a time stamp, and payload data. Such fields of a bet may include a pool ID, an outcome of the potential outcomes of the pool, and a bet amount.

In block 406, the processing device may publish the bet to the blockchain. The processing device may broadcast the bet to the computing network and the bet may be stored on multiple computing devices. To publish the bet, the computing devices receiving the bet may validate the data of the bet, as described further herein with reference to FIGS. 2A and 2B. The current example assumes that validation of the bet is successful. Otherwise, publication of the bet to the blockchain may fail. The data of the bet type action may link the bet to another action existing on the blockchain. For example, the bet may be linked to the genesis block or a previous action of the user. For example, the reference ID may be an ID of a previous action of the user, such as a vote by the user or a transaction to the user, which represents sufficient currency to cover the amount of the bet.

In block 408, the processing device may hold the bet amount. The processing device may disassociate the bet currency from the user making the bet and hold the currency in an ownerless state until the bet is settled. In the ownerless state, the currency may be held without association with a user address.

FIG. 5 illustrates a method 500 for placing votes on the pool of the blockchain according to an embodiment. The method 500 may further describe embodiments of block 318 of the method 300 described herein with reference to FIG. 3. In block 502, the processing device may receive data for voting on the pool. Any user of the computing network (e.g., computing network 100 in FIG. 1) assigned a vote that is assigned to a voting partition that includes the pool may send data for voting on the pool via a computing device, and that data may be received by the processing device. The data may include a pool ID, outcome, and/or a number of votes being contributed. In some embodiments, the pool ID may be the action ID and element ID pair associated with the pool on which the vote may be placed. In some embodiments, the pool ID may be the action ID associated with the pool on which the vote may be placed. The outcome may be a value, such as an integer, corresponding to an index of the outcome in the pool's potential outcomes on which the vote may be placed. Other data relating to the user, such as account data including the user's address and public key, and type of action or type of element the user is requesting, such as a vote, may be received by the processing device. This other data may be received from the software used by the user to enter data and request the action, and/or from data repositories on other computing devices of the computing network that may be queried in response to the user's provision of the data.

In block 504, the processing device may generate a vote on the pool. The processing device may generate a vote type action, using the data received in block 504 to populate and to generate other data to populate fields of the vote type action. In some embodiments, the processing device may generate the vote type action having a vote type element discussed herein with reference to FIG. 2A. For example, the fields may be the fields of an action, a payload, an element, and a vote. Such fields of an action may include an action ID, a signature of the user, and a payload. Such fields of a payload may include a public key of the user, an address of the user, an input reference ID(s), an output reference ID(s), and payload data. Such fields of an element may include an element type and a nonce. Such fields of a vote may include a pool ID, an outcome of the potential outcomes of the pool, and a number of votes being contributed. In some embodiments, the processing device may generate the vote type action having a vote type payload discussed herein with reference to FIG. 2B. For example, the fields may be the fields of an action, a payload, and a vote. Such fields of an action may include an action ID, a signature of the user, a payload. Such fields of a payload may include an action type, a public key of the user, an address of the user, a reference ID, a time stamp, and payload data. Such fields of a vote may include a pool ID, and an outcome of the potential outcomes of the pool.

In block 506, the processing device may publish the vote to the blockchain. The processing device may broadcast the vote to the computing network and the vote may be stored on multiple computing devices. To publish the vote, the computing devices receiving the vote may validate the data of the vote, as described further herein with reference to FIGS. 2A and 2B. The current example assumes that validation of the vote is successful. Otherwise, publication of the vote to the blockchain may fail. The data of the vote type action may link the vote to another action existing on the blockchain. For example, the vote may be linked to the genesis block or a previous action of the user. For example, the reference ID may be an ID of a previous action of the user, such as the bet by the user that resulted in the vote assignment. For example, the vote may be linked to the bet existing on the blockchain on which the vote may be placed using the action ID of the bet.

FIG. 6 illustrates a method 600 for determining an outcome(s) of the pool of the blockchain according to an embodiment. The method 600 may further describe embodiments of block 324 of the method 300 described herein with reference to FIG. 3. In block 602, the processing device may identify one or more majority outcomes of the pool based on votes on the pool. The processing device may track on which of the outcomes of the pool the most votes are placed, referred to herein as the majority outcomes.

In block 604, the processing device may determine whether the one or more majority outcomes for the pool are potential outcomes for the pool. The pool may be generated with user defined potential outcomes. In some embodiments, the software used by the user may include a default outcome, in the user defined potential outcomes, on which votes may be placed for outcomes that are not included in the user defined potential outcomes. In some embodiments, the processing device may add a default outcome, to the user defined potential outcomes, on which votes may be placed for outcomes that are not included in the user defined potential outcomes. Votes may be placed on the potential outcomes of the pool. In response to the majority of votes being placed on one or more of the user defined potential outcomes, the one or more outcomes for the pool may be one or more potential outcomes for the pool. In response to the majority of votes being placed on the default outcome, the outcome for the pool may not be a potential outcome for the pool. An outcome for the pool that may not be a potential outcome for the pool may be referred to herein as a “no-contest” result.

FIGS. 7A and 7B illustrate methods 700a, 700b for assigning a vote(s) to a user(s) of a bet(s) on the pool of the blockchain according to an embodiment. The method 700a may further describe embodiments of block 326 of the method 300 described herein with reference to FIG. 3. In some embodiments, the methods 700a, 700b may be alternatively implemented to each other.

FIG. 7A illustrates the method 700a for assigning a vote(s) to a user(s) of a winning bet(s) on the pool of the blockchain according to an embodiment. In block 702, the processing device may identify a winning bet(s) on the pool based on the majority outcome(s) of the pool. The processing device may identify a bet having an outcome that is the same as the majority outcome(s) of the pool identified in block 602 of the method 600 described herein with reference to FIG. 6. The processing device may compare information of the bet, such as an outcome, to the winning outcome(s) to identify which bets correspond to the winning outcome(s).

In block 704, the processing device may identify a winning user(s) based on the winning bet(s) on the pool. The processing device may identify the winning user as the user associated with the winning bet identified in block 702. For example, the processing device may use the user's address associated with the bet to identify the winning user.

In block 706, the processing device may assign a voting partition(s) for the vote(s) for the winning user(s). The processing device may assign an approximation of a random set of pools on the blockchain for a vote resulting from a winning bet on the pool. The pools of the voting partition may be determined as described herein with reference to FIGS. 2A and 2B. The voting partitions may represent the subsets of the pools on the blockchain on which the vote resulting from the winning bet on the pool may be cast.

In block 708, the processing device may assign a vote(s) and a voting partition(s) to the winning user(s). In some embodiments, the processing device may assign a number of votes per winning bet or winning user. For example, the processing device may assign an equal number of votes per winning bet or winning user. For another example, the processing device may assign a number of voters per winning bet or winning user based on the value of the winning bet. The value of the winning bet may be the amount wagered on the bet and/or the amount of the winnings of the winning bet. The voting partition assigned to the winning user may be determined as described herein with reference to FIGS. 2A and 2B. The winning user may be enabled to cast the votes assigned as a winning user on the pools of the voting partition assigned as a winning user.

FIG. 7B illustrates the method 700b for assigning a vote(s) to a user(s) of a bet(s) on the pool of the blockchain having a “no-contest” result according to an embodiment. In block 710, the processing device may identify a bet(s) on the pool having a “no-contest” result. The processing device may identify a bet having a pool ID that is the same as the pool ID of the pool having a “no-contest” result identified in block 604 of the method 600 described herein with reference to FIG. 6. The processing device may compare information of the bet, such as the pool ID, to information of the pool having a “no-contest” result, such as the pool ID, to identify which bets correspond to the pool having a “no-contest” result.

In block 712, the processing device may identify a user(s) based on the bet(s) on the pool. The processing device may identify the user as the user associated with the bet identified in block 702. For example, the processing device may use the user's address associated with the bet to identify the user.

In block 714, the processing device may assign a voting partition(s) for the vote(s) for the user(s). The processing device may assign an approximation of a random set of pools on the blockchain for a vote resulting from a bet on the pool having a “no-contest” result. The pools of the voting partition may be determined as described herein with reference to FIGS. 2A and 2B. The voting partitions may represent the subsets of the pools on the blockchain on which the vote resulting from the bet on the pool having a “no-contest” result may be cast.

In block 716, the processing device may assign a vote(s) and a voting partition(s) to the user(s). In some embodiments, the processing device may assign a number of votes per bet or user. For example, the processing device may assign an equal number of votes per bet or user. For another example, the processing device may assign a number of voters per bet or user based on the value of the bet. The value of the bet may be the amount wagered on the bet. The voting partition assigned to the winning user may be determined as described herein with reference to FIGS. 2A and 2B. The user may be enabled to cast the votes assigned as a user of a bet placed on the pool having a “no-contest result” on the pools of the voting partition assigned as a user of a bet placed on the pool having a “no-contest result”.

FIGS. 8A, 8B, and 8C illustrate methods 800a, 800b, 800c for determining a payout(s) for bet(s) on another pool(s) of the blockchain according to an embodiment. The methods 800a, 800b, 800c may further describe block 328 of the method 300 described herein with reference to FIG. 3. In some embodiments, the methods 800a, 800b, 800c may be alternatively implemented to each other.

FIG. 8A illustrates the method 800 a for determining a payout(s) for winning bet(s) on another pool(s) of the blockchain according to an embodiment. In block 802, the processing device may determine a vote(s) placed on the pool for and/or against the majority outcome(s). The processing device may identify a vote having an outcome that is the same as the majority outcome(s) of the pool identified in block 602 of the method 600 described herein with reference to FIG. 6. The processing device may compare information of the vote, such as an outcome, to the winning outcome(s) to identify which votes correspond to the winning outcome(s).

In block 804, the processing device may calculate available currency for the vote(s) based on the bet(s) and/or forfeit currency. A user placing a vote identified as for the majority outcome(s) may receive a payout of winnings and a user placing a vote identified as against the majority outcome(s) may forfeit winnings. The processing device may calculate the payout of the winnings for the user placing the vote identified as for the majority outcome(s) based on the amount wagered and the outcome of the bets placed on the other pool and/or any forfeit winnings as described herein with reference to FIGS. 2A and 2B. The processing device may calculate the payout of the winnings for the user placing the vote identified as against the majority outcome as forfeit or zero (0) currency. In some embodiments, the processing device may identify the pool and/or bet from which the vote was generated using data of the vote type action, such as a reference ID being the action ID and element ID pair of the pool and/or bet type action the vote type action references. In some embodiments, the processing device may identify the pool and/or bet from which the vote was generated using data of the vote type action, such as a reference ID being the action ID of the pool and/or bet type action the vote type action references.

In block 806, the processing device may assign currency to the user(s) associated with the vote(s) placed on the pool for the majority outcome. The processing device may identify the user associated with the vote having an outcome(s) that is the same as the majority outcome(s) of the pool. The processing device may use information of the vote, such as an address, to identify which user corresponds to the vote.

In block 808, the processing device may assign currency to a pool creator user associated with the vote(s) placed on the pool for the majority outcome. The processing device may identify the pool creator user associated with the vote having an outcome that is the same as the majority outcome(s) of the pool. The currency may be a fee for creating a pool in which the majority outcome(s) was a potential outcome(s) of the pool. The currency may be a reward for creating a pool in which the majority outcome(s) was a potential outcome(s) of the pool, as described herein with reference to FIGS. 2A and 2B.

FIG. 8B illustrates the method 800b for implementing a transaction(s) for winning bet(s) on another pool(s) of the blockchain according to an embodiment. The processing device may implement blocks 802, 806, 808 in a similar manner as the method 800a described herein with reference to FIG. 8A. In block 805, the processing device may calculate available currency for the vote(s) based on the bet(s). A user placing a vote identified as for the majority outcome(s) may receive a payout of winnings and a user placing a vote identified as against the majority outcome(s) may forfeit winnings The processing device may calculate the payout of the winnings for the user placing the vote identified as for the majority outcome(s) based on the amount wagered and the outcome of the bets placed on the other pool as described herein with reference to FIGS. 2A and 2B. The processing device may calculate the payout of the winnings for the user placing the vote identified as against the majority outcome as forfeit or zero (0) currency. In some embodiments, the processing device may identify the pool and/or bet from which the vote was generated using data of the vote type action, such as a reference ID being the action ID and element ID pair of the pool and/or bet type action the vote type action references. In some embodiments, the processing device may identify the pool and/or bet from which the vote was generated using data of the vote type action, such as a reference ID being the action ID of the pool and/or bet type action the vote type action references.

In block 810, the processing device may assign forfeit currency to a master user.

FIG. 8C illustrates the method 800c for determining a payout(s) for bet(s) on another pool(s) of the blockchain having a “no-contest” result according to an embodiment. The processing device may implement block 802 in a similar manner as the method 800a described herein with reference to FIG. 8A. In block 814, the processing device may assign currency of bet(s) on the pool to the user(s) associated with the bet(s). Without a winning outcome on the pool having the “no-contest” result there may be no winning bet, and the user who placed the bet on the pool may be returned the wager amount. The processing device may use data of the bet, such as the amount wagered, to determine the amount of currency, such as votes, to assign. The processing device may generate and publish a transaction assigning the currency to the user in a similar manner as described herein for block 806, using the address of the user as the recipient address and the bet amount as the amount of currency.

In block 816, the processing device may assign fee currency to a master user.

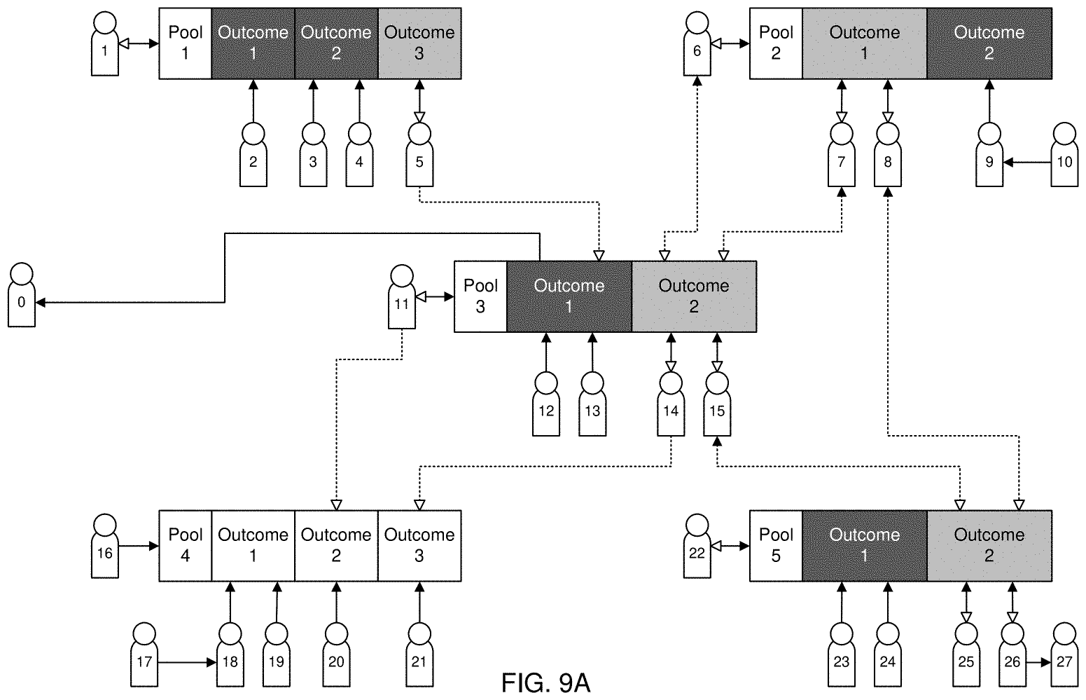

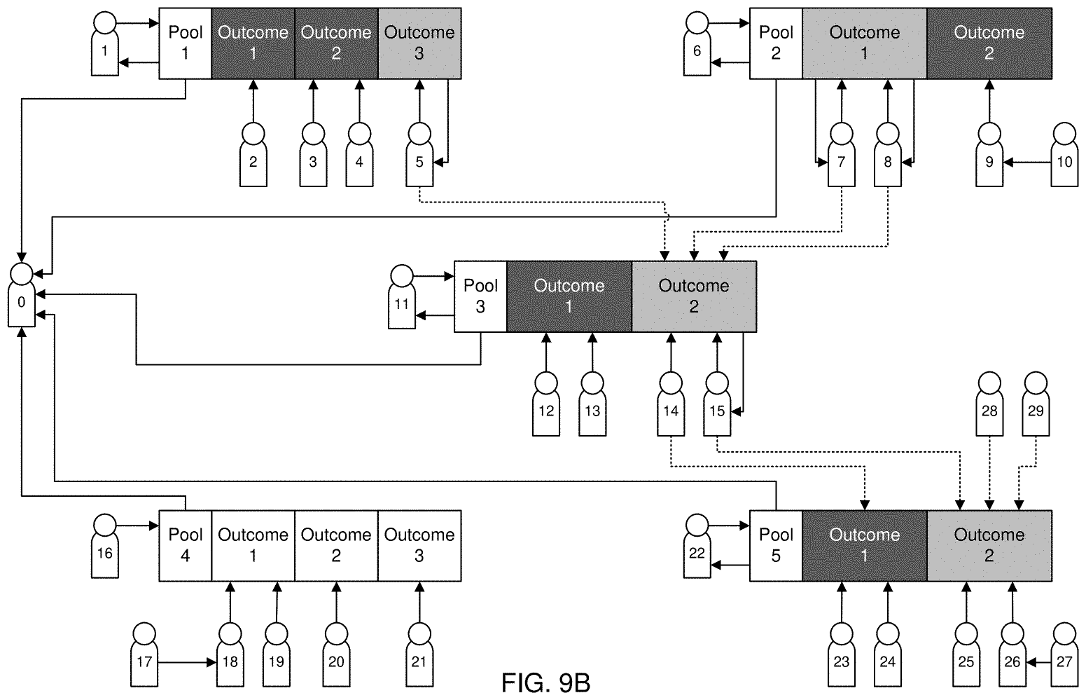

FIGS. 9A and 9B illustrate examples of implementing trusted real-world event outcomes on a blockchain according to various embodiments. With reference to FIGS. 1-9B, the examples illustrated in FIGS. 9A and 9B may be implemented on multiple computing devices (e.g., computing device 104a-104c, 106a-106c, 108a-108c in FIG. 1, computing device 200a, 200b in FIGS. 2A and 2B) of the computing network (e.g., computing network 100 in FIG. 1). For example, each user 0-29 may use a computing device, and each pool 1-5 may be hosted on multiple computing devices.

To ensure trust in the users of the computing network, each oracle, or voting user, may have an incentive to vote honestly or a disincentive to vote dishonestly. To achieve the trust a staked voting algorithm may be implemented, where winning bettors of pools vote on an approximately random pool(s) before redeeming their winnings This methodology is premised on the concept that the easiest way to ensure consensus among strangers is with the truth. Additionally, approximately randomizing pool selection for a given voter defends against a Sybil attack. A Sybil attack, in this scenario, would be one where a user could gain an advantage “controlling” a disproportionate percentage of the voting power simply by generating a large number of distinct accounts. In a voting system, this would allow a single user to place many votes on an event's outcome with a relatively small upfront cost. Assigning approximately random pools on which users may place votes deters a user from attempting this type of attack. Controlling many accounts will not guarantee controlling many votes on a single event.

Using this staked voting method of outcome determination, each vote relies on a previous bet and, therefore, the computing network may run itself as long as subsequent pools are created and bets are placed.

In the example illustrated in FIG. 9A, user 0 may be the master user. User 1 may be a pool creator user of pool 1, user 6 may be a pool creator user of pool 2, user 11 may be a pool creator user of pool 3, user 16 may be a pool creator user of pool 4, and user 22 may be a pool creator user of pool 5. Each of user 1, user 6, user 11, user 16, and user 22 may pay a fee using currency, such as coins, to create the respective pools, illustrated by a solid arrow on a solid line pointing from the users to the respective pools.

Users 2-5 may be bettors on pool 1, users 7-9 may be bettors on pool 2, users 12-15 may be bettors on pool 3, users 18-21 may be bettors on pool 4, users 23-26 may be bettors on pool 5. Each of users 2-5, users 7-9, users 12-15, users 18-21, and users 23-26 may place bets using currency, such as coins, on outcomes of the respective pools, illustrated by a solid arrow on a solid line pointing from the users to the respective outcomes of the respective pools. For example, user 2 may place a bet on outcome 1 of pool 1, users 3 and 4 may each place a bet on outcome 2 of pool 1, and user 5 may place a bet on outcome 3 of pool 1.

Shading of the outcomes of the pools 1-3 and 5 may indicate that the pools have been voted on and a lack of shading of the outcomes of the pool 4 may indicate that the pool has yet to be voted on. Lighter shading may indicate the majority outcome of the pool, such as outcome 3 of pool 1, outcome 1 of pool 2, outcome 2 of pool 3, and outcome 2 of pool 5. Darker shading may indicate a minority outcome of the pool. Bettors who bet on majority outcomes may be assigned votes for voting on other pools, illustrated by an open arrow on a solid line pointing from outcomes of the pools to the respective users. Pool creator users who create a pool resulting in a majority outcome, confirmed by votes, may be assigned votes for voting on other pools, as a fee and/or reward, illustrated by an open arrow on a solid line pointing from the pools to the respective pool creator users. Pool creator users 1, 6, 11, and 22 may be assigned votes as their respective pools 1, 2, 3, and 5 have resulted in a majority outcome. Users assigned votes may place their votes on outcomes of other pools, illustrated by an open arrow on a broken line pointing from the users to the outcome of other pools. Users 5, 6, and 7 are voters on pool 3, users 11 and 14 are voters on pool 4, and users 8 and 15 are voters on pool 5. Bettors who bet against the majority outcomes may not be assigned votes. Votes on pools 1 and 2 are omitted for simplicity and clarity.

Users 6 and 7 vote on the majority outcome of pool 3, outcome 2, and users 8 and 15 vote on the majority outcome of pool 5, outcome 2, illustrated by open arrows on broken lines from the users to the outcome. User 5 votes on the minority outcome, or against the majority outcome, of pool 3, outcome 1, illustrated by an open arrow on a broken line from the users to the outcome. User 11 votes on outcome 2 of pool 4 and user 14 vote on outcome 3 of pool 4, illustrated by open arrows on broken lines from the users to the outcome, where no majority outcome has been determined for pool 4.

As a result, voting for the majority outcomes, pool creator user 6 receives fees and/or awards and users 7, 8, and 15 receive winnings from pools 2 and 5 respectively, illustrated by solid arrows on broken lines from the pools to the respective users. As a result, voting against the majority outcome, user 5 forfeits winnings from pool 1, illustrated by lack of a solid arrow on a broken line from the pool to the respective user. The result of pool 4 is yet to be determined, so pool creator user 11 has yet to be awarded or forfeit fees and/or awards from pool 3 and user 14 has yet to be awarded or forfeit winnings from pool 3, illustrated by lack of a solid arrow on a broken line from the pool to the respective user.

The master user 0 receives forfeited winnings of the bet placed by user 5 on pool 3, illustrated by a solid arrow on a solid line from the pool 3 to user 0.

Transactions of currency may occur between any users. Users 10 transfers currency to user 9, user 17 transfers currency to user 18, and user 26 transfers currency to user 27, illustrated by solid arrows on solid lines between the respective users.

In the example illustrated in FIG. 9B, user 0 may be the master user. User 1 may be a pool creator user of pool 1, user 6 may be a pool creator user of pool 2, user 11 may be a pool creator user of pool 3, user 16 may be a pool creator user of pool 4, and user 22 may be a pool creator user of pool 5. Each of user 1, user 6, user 11, user 16, and user 22 may pay a fee to create the respective pools, illustrated by a solid arrow pointing from the users to the respective pools.

Users 2-5 may be bettors on pool 1, users 7-9 may be bettors on pool 2, users 12-15 may be bettors on pool 3, users 18-21 may be bettors on pool 4, users 23-26 may be bettors on pool 5. Each of users 2-5, users 7-9, users 12-15, users 18-21, and users 23-26 may place bets on outcomes of the respective pools, illustrated by a solid arrow pointing from the users to the respective outcomes of the respective pools. For example, user 2 may place a bet on outcome 1 of pool 1, users 3 and 4 may each place a bet on outcome 2 of pool 1, and user 5 may place a bet on outcome 3 of pool 1.

Shading of the outcomes of the pools 1-3 and 5 may indicate that the pools have been voted on and a lack of shading of the outcomes of the pool 4 may indicate that the pool has yet to be voted on. Lighter shading may indicate the majority outcome of the pool, such as outcome 3 of pool 1, outcome 1 of pool 2, outcome 2 of pool 3, and outcome 2 of pool 5. Darker shading may indicate a minority outcome of the pool. Bettors who bet on majority outcomes may be assigned votes for voting on other pools. Users 5, 7, and 8 are voters on pool 3, and users 14, 15, 28, and 29 are voters on pool 5. Bets made by users 28 and 29 are omitted for simplicity and clarity, however, it may be implied that users 28 and 29 bet on majority outcomes of respective pools. Bettors who bet against the majority outcomes may not be assigned votes. Votes on pools 1 and 2 are omitted for simplicity and clarity.

Users 5, 7, and 8 vote on the majority outcome of pool 3, outcome 2, illustrated by broken arrows from the users to the outcome. Users 15, 28, and 29 vote on the majority outcome of pool 5, outcome 2, illustrated by broken arrows from the users to the outcome. User 14 votes on the minority outcome, or against the majority outcome, of pool 5, outcome 1, illustrated by broken arrows from the user to the outcome.

As a result, voting for the majority outcomes, users 5, 7, 8, 15, 28, and 29 receive winnings from pools 1, 2, and 3 respectively, illustrated by solid arrows from the pools to the respective users. As a result, voting against the majority outcome, user 14 forfeits winnings from pool 3, illustrated by lack of a solid arrow from the pool to the respective user.

Users 1, 6, 11, and 22 receive fees for creating pools in which a majority outcome is confirmed by votes, illustrated by solid arrows from the pools to respective users. The master user 0 receives fees for placing bets on pools, fees for creating pools, and/or forfeit winnings, illustrated by solid lines from the pools to user 0.

Transactions of currency may occur between any users. Users 10 transfers currency to user 9, user 17 transfers currency to user 18, and user 27 transfers currency to user 26, illustrated by solid arrows between the respective users.

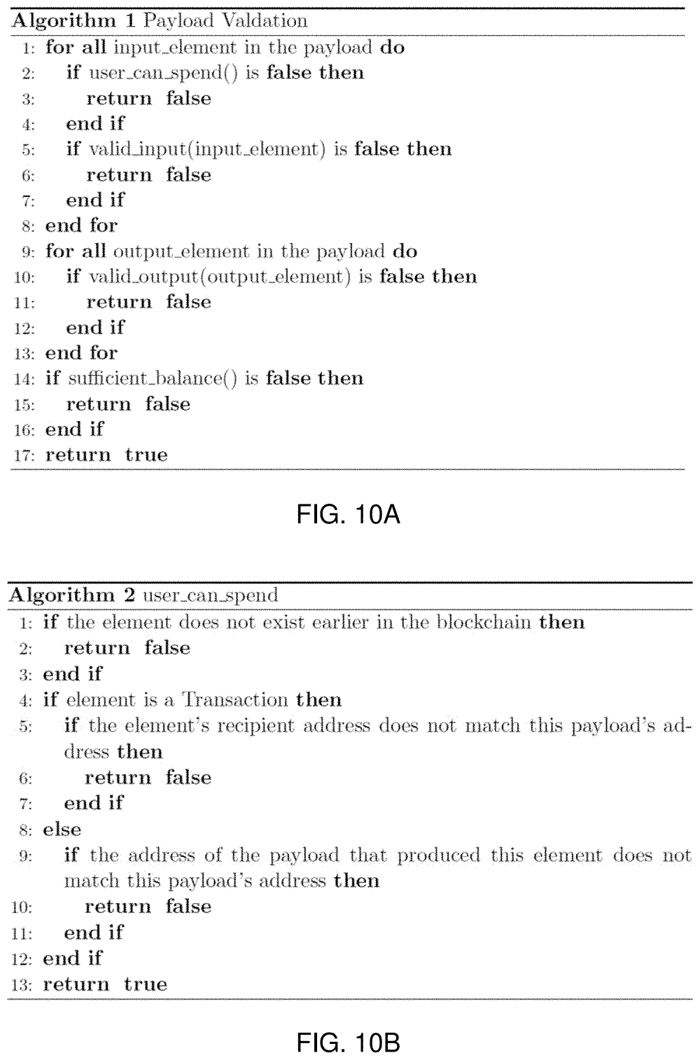

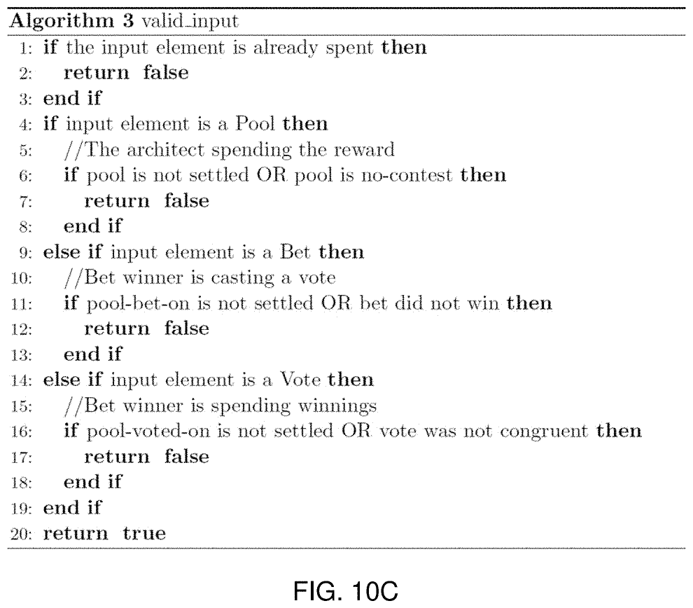

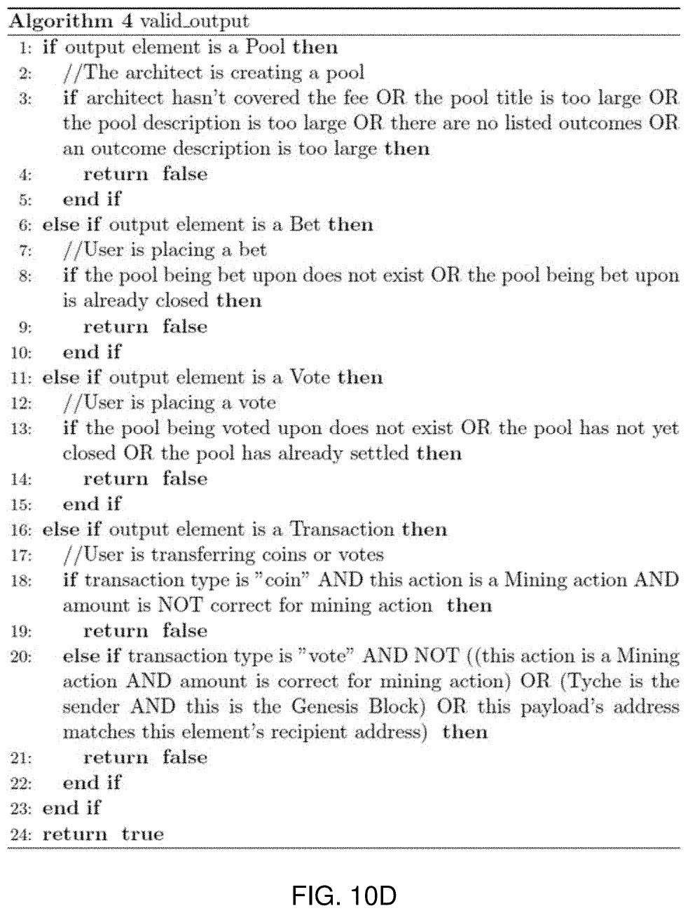

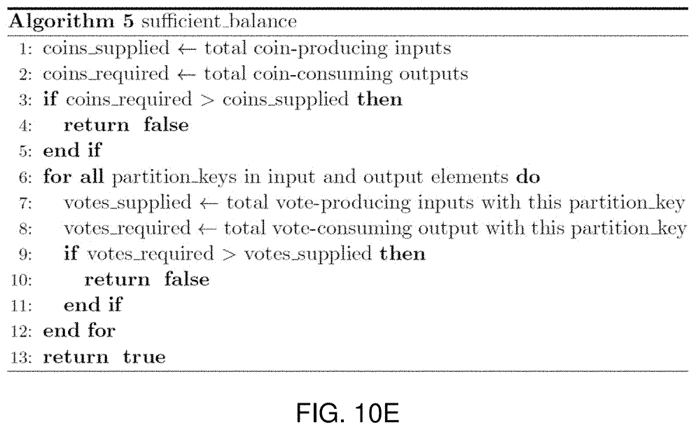

FIGS. 10A-10E illustrated examples of pseudo code for implementing validation for trusted real-world event outcomes on a blockchain according to an embodiment. With reference to FIGS. 1-10E, the pseudo code may be examples of software (e.g., modules 202a-226 in FIG. 2) stored on various memories/caches (e.g., memory 1106 in FIG. 11, 1212, 1213 in FIG. 12, memory 1302, 1304 in FIG. 13) and executable on a processor (e.g., processor 1102 in FIG. 11, processor 1202 in FIG. 12, processor 1601 in FIG. 13) of a computing device (e.g., computing device 104a-104c, 106a-106c, 108a-108c in FIG. 1, computing device 200 in FIG. 2).

FIG. 10A illustrates an example of pseudo code configured for validation of a payload of an action. The pseudo code may be configured to execute validation for each element (e.g., input_element) referenced by the payload, including: whether a referenced element is owned or created by the user creating the payload (e.g., user_can_spend called in FIG. 10A and illustrated in FIG. 10B) and, therefore, may include currency, such as coin or votes, to support the payload; whether the referenced element is available to support the payload (e.g., valid_input called in FIG. 10A and illustrated in FIG. 10C); whether each new element being created in the payload is valid (e.g., valid_ouput called in FIG. 10A and illustrated in FIG. 10D); and whether the referenced elements provide sufficient balance to support the payload (e.g., sufficient_balance called in FIG. 10A and illustrated in FIG. 10E).

FIG. 10B illustrates an example of pseudo code configured for validation of whether each referenced element is owned or created by the user creating the payload. The pseudo code may be configured to validate: whether the referenced element exists; if the referenced element is a transaction, whether the recipient of the transaction is the same as the creator of the payload; and whether the creator of the referenced element is the creator of the payload.

FIG. 10C illustrates an example of pseudo code configured for validation of whether each referenced element is available to support the payload. The pseudo code may be configured to validate: whether the referenced element is already spent; if the referenced element is a pool, whether a reward for publishing the pool is available; if the referenced element is a bet, whether the bet is a winning bet with a currency value; if the referenced element is a vote, whether the vote was placed on a majority outcome of a pool.

FIG. 10D illustrates an example of pseudo code configured for validation of whether use of the payload is valid. The pseudo code may be configured to validate: if the element is for a pool, whether the conditions for creating a pool are met; if the element is for a bet, whether the bet is placed on an appropriate pool; if the element is for a vote, whether the vote is placed on an appropriate pool; and if the element is for a transaction sending currency, whether the encompassing action is a mining action and the correct amount is being sent; and if the element is for a transaction that is sending votes, whether the encompassing action is a mining action and the correct amount is being sent, whether the transaction's sender is the master address and the payload's address is the genesis block, or whether the transaction's recipient address matches the payload's address.

FIG. 10E illustrates an example of pseudo code configured for validation of whether the referenced elements provide sufficient balance to support the payload. The pseudo code may be configured to validate: whether amounts of currency supplied by the referenced elements are sufficient to cover the amount of currency required by the payload; and whether numbers of votes supplied for a vote partition by the referenced elements are sufficient to cover the number of votes required by the payload for the vote partition.

A system in accordance with the various embodiments (including, but not limited to, embodiments described above with reference to FIGS. 1-10E) may be implemented in a wide variety of computing systems including mobile computing devices, an example of which suitable for use with the various embodiments is illustrated in FIG. 11. The mobile computing device 1100 may include a processor 1102 coupled to a touchscreen controller 1104 and an internal memory 1106. The processor 1102 may be one or more multicore integrated circuits designated for general or specific processing tasks. The internal memory 1106 may be volatile or non-volatile memory, and may also be secure and/or encrypted memory, or unsecure and/or unencrypted memory, or any combination thereof. Examples of memory types that can be leveraged include but are not limited to DDR, Low-Power DDR (LPDDR), Graphics DDR (GDDR), WIDEIO, RAM, Static RAM (SRAM), Dynamic RAM (DRAM), Parameter RAM (P-RAM), Resistive RAM (R-RAM), Magnetoresistive RAM (M-RAM), Spin-Transfer Torque RAM (STT-RAM), and embedded DRAM. The touchscreen controller 1104 and the processor 1102 may also be coupled to a touchscreen panel 1112, such as a resistive-sensing touchscreen, capacitive-sensing touchscreen, infrared sensing touchscreen, etc. Additionally, the display of the mobile computing device 1100 need not have touch screen capability.

The mobile computing device 1100 may have one or more radio signal transceivers 1108 (e.g., Peanut, Bluetooth, ZigBee, Wi-Fi, RF radio) and antennae 1110, for sending and receiving communications, coupled to each other and/or to the processor 1102. The transceivers 1108 and antennae 1110 may be used with the above-mentioned circuitry to implement the various wireless transmission protocol stacks and interfaces. The mobile computing device 1100 may include a cellular network wireless modem chip 1116 that enables communication via a cellular network and is coupled to the processor.

The mobile computing device 1100 may include a peripheral device connection interface 1118 coupled to the processor 1102. The peripheral device connection interface 1118 may be singularly configured to accept one type of connection, or may be configured to accept various types of physical and communication connections, common or proprietary, such as Universal Serial Bus (USB), FireWire, Thunderbolt, or PCIe. The peripheral device connection interface 1118 may also be coupled to a similarly configured peripheral device connection port (not shown).

The mobile computing device 1100 may also include speakers 1114 for providing audio outputs. The mobile computing device 1100 may also include a housing 1120, constructed of a plastic, metal, or a combination of materials, for containing all or some of the components described herein. The mobile computing device 1100 may include a power source 1122 coupled to the processor 1102, such as a disposable or rechargeable battery. The rechargeable battery may also be coupled to the peripheral device connection port to receive a charging current from a source external to the mobile computing device 1100. The mobile computing device 1100 may also include a physical button 1124 for receiving user inputs. The mobile computing device 1100 may also include a power button 1126 for turning the mobile computing device 1100 on and off.

A system in accordance with the various embodiments (including, but not limited to, embodiments described above with reference to FIGS. 1-10E) may be implemented in a wide variety of computing systems include a laptop computer 1200 an example of which is illustrated in FIG. 12. Many laptop computers include a touchpad touch surface 1217 that serves as the computer's pointing device, and thus may receive drag, scroll, and flick gestures similar to those implemented on computing devices equipped with a touch screen display and described above. A laptop computer 1200 will typically include a processor 1202 coupled to volatile memory 1212 and a large capacity nonvolatile memory, such as a disk drive 1213 of Flash memory. Additionally, the computer 1200 may have one or more antenna 1208 for sending and receiving electromagnetic radiation that may be connected to a wireless data link and/or cellular telephone transceiver 1216 coupled to the processor 1202. The computer 1200 may also include a floppy disc drive 1214 and a compact disc (CD) and/or digital video disc (DVD) drive 1215 coupled to the processor 1202. In a notebook configuration, the computer housing includes the touchpad 1217, the keyboard 1218, and the display 1219 all coupled to the processor 1202. Other configurations of the computing device may include a computer mouse or trackball coupled to the processor (e.g., via a USB input) as are well known, which may also be used in conjunction with the various embodiments.

A system in accordance with the various embodiments (including, but not limited to, embodiments described above with reference to FIGS. 1-10E) may also be implemented in fixed computing systems, such as any of a variety of commercially available servers. An example server 1300 is illustrated in FIG. 13. Such a server 1300 typically includes one or more multicore processor assemblies 1301 coupled to volatile memory 1302 and a large capacity nonvolatile memory, such as a disk drive 1304. As illustrated in FIG. 13, multicore processor assemblies 1301 may be added to the server 1300 by inserting them into the racks of the assembly. The server 1300 may also include a floppy disc drive, compact disc (CD) or digital versatile disc (DVD) disc drive 1306 coupled to the processor 1301. The server 1300 may also include network access ports 1303 coupled to the multicore processor assemblies 1301 for establishing network interface connections with a network 1305, such as a local area network coupled to other broadcast system computers and servers, the Internet, the public switched telephone network, and/or a cellular data network (e.g., CDMA, TDMA, GSM, PCS, 3G, 4G, LTE, 5G or any other type of cellular data network).

Implementation examples are described in the following paragraphs. While some of the following implementation examples are described in terms of example systems, devices, or methods, further example implementations may include: the example systems or devices discussed in the following paragraphs implemented as a method executing operations of the example systems or devices, the example systems, devices, or methods discussed in the following paragraphs implemented by a computing device comprising a processing device configured with processing device-executable instructions to perform operations of the example systems, devices, or methods; the example systems, devices, or methods discussed in the following paragraphs implemented by a computing device including means for performing functions of the example systems, devices, or methods; and the example systems, devices, or methods discussed in the following paragraphs implemented as a non-transitory processor-readable storage medium having stored thereon processor-executable instructions configured to cause a processor of a computing device to perform the operations of the example systems, devices, or methods.

Example 1. A method for implementing trusted real-world event outcomes on a blockchain, including placing a vote on an outcome of a first pool for a real-world event, in which the vote is linked on the blockchain to an existing action associated with a currency value, determining whether the vote is placed on a majority outcome of at least one majority outcome of the first pool, and determining a currency payout for the vote to a user in response to determining that the vote is placed on the majority outcome of the first pool.

Example 2. The method of example 1, further including identifying the majority outcome from a plurality of outcomes of the first pool based on a plurality of votes, including the vote, placed on the plurality of outcomes, in which each of the plurality of votes is linked on the blockchain to an existing action associated with a currency value.

Example 3. The method of either example 1 or 2, further including identifying a bet on a second pool, in which the existing action is an action of the bet and the bet is placed on a majority outcome of at least one majority outcome of the second pool, identifying the user associated with the bet, assigning at least one voting partition of a first plurality of pools for real-world events to the user, in which the first plurality of pools is a subset of a second plurality of pools for real-world events and in which the first plurality of pools includes the first pool, and assigning at least one vote, including the vote, to the user that can be placed on a pool of the first plurality of pools.

Example 4. The method of any of examples 1-3, further including identifying a majority outcome of a second pool as a no-contest outcome in which the existing action is an action of a bet on the second pool, identifying the bet, identifying the user associated with the bet, assigning at least one voting partition of a first plurality of pools for real-world events to the user, in which the first plurality of pools is a subset of a second plurality of pools for real-world events and in which the first plurality of pools includes the first pool, and assigning at least one vote, including the vote, to the user that can be placed on a pool of the first plurality of pools.

Example 5. The method of any of examples 1-4, in which the existing action is an action of a bet on a second pool and the bet is a winning bet placed on a majority outcome of at least one majority outcome of the second pool, the method further including in response to determining that the vote is placed on the majority outcome of the first pool calculating the currency payout for the vote on the first pool based on a plurality of bets made on the second pool, including the bet.

Example 6. The method of any of examples 1-5, further including assigning forfeit currency of at least one bet on the second pool linked on the blockchain to a vote placed against a majority outcome of a third pool for a real-world event to a master user.

Example 7. The method of any of examples 1-6, in which the existing action is an action of a bet on a second pool and a majority outcome of the second pool is a no-contest outcome, the method further including assigning the currency amount of the bet on the second pool as the currency payout for the vote on the first pool in response to determining that the vote is placed on the majority outcome of the first pool.

Example 8. The method of any of examples 1-7, in which the existing action includes one of a bet on a second pool for a real-world event, a transaction to the user, or a reward to the user as a pool creator user.

Example 9. A method for implementing trusted real-world event outcomes on a blockchain, including generating a first pool for a real-world event including a plurality of potential outcomes for the real-world event, generating a bet on the first pool including a first potential outcome of the plurality of potential outcomes, publishing the bet to the blockchain linked to the first pool, generating a vote on a second pool for a real-world event including a second potential outcome of a plurality of potential outcomes included on the second pool, publishing the vote to the blockchain linked to the bet, and determining a currency payout based at least in part on a currency amount of the bet to a user associated with the vote.

Example 10. The method of example 9, in which generating the vote on the second pool includes generating the vote on the second pool in response to the first potential outcome being a majority outcome of at least one majority outcome of the first pool.

Example 11. The method of example 9 or 10, in which generating the vote on the second pool includes generating the vote on the second pool in response to a majority outcome of the first pool being a non-contest outcome.

Example 12. The method of any of examples 9-11, in which determining the currency payout includes determining the currency payout in response to the second potential outcome being a majority outcome of at least one majority outcome of the second pool.

Example 13. The method of any of examples 9-12, further including assigning a currency fee to a pool creator user associated with the first pool in response to at least one of the plurality of potential outcomes for the real-world event being at least one majority outcome of the first pool.

Example 14. The method of any of examples 9-13, further including assigning a currency reward to a pool creator user associated with the first pool in response to at least one of the plurality of potential outcomes for the real-world event being at least one majority outcome of the first pool.

Example 15. The method of any of examples 9-14, further including assigning currency associated with the vote to a master user in response to all majority outcomes of the second pool being at least one potential outcome of the plurality of potential outcomes included on the second pool other than the second potential outcome.

Example 16. The method of any of examples 9-15, in which the plurality of potential outcomes for the event include at least one non-binary outcome.

Computer program code or “program code” for execution on a programmable processor for carrying out operations of the various embodiments may be written in a high level programming language such as C, C++, C#, Smalltalk, Java, JavaScript, Visual Basic, a Structured Query Language (e.g., Transact-SQL), Perl, Python or in various other programming languages. Program code or programs stored on a computer readable storage medium as used in this application may refer to machine language code (such as object code) whose format is understandable by a processor.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the various embodiments may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or a non-transitory processor-readable medium. The operations of a method or algorithm disclosed herein may be embodied in a processor-executable software module that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments and implementations without departing from the scope of the claims. Thus, the present disclosure is not intended to be limited to the embodiments and implementations described herein, but is to be accorded the widest scope consistent with the following claims and the principles and novel features disclosed herein.

What is claimed is:

1. A method for implementing trusted real-world event outcomes on a blockchain, comprising:
placing a vote on an outcome of a first pool for a real-world event, wherein the vote is linked on the blockchain to an existing action associated with a currency value;
determining whether the vote is placed on a majority outcome of at least one majority outcome of the first pool; and
determining a currency payout for the vote to a user in response to determining that the vote is placed on the majority outcome of the first pool.

2. The method of claim 1, further comprising identifying the majority outcome from a plurality of outcomes of the first pool based on a plurality of votes, including the vote, placed on the plurality of outcomes, wherein each of the plurality of votes is linked on the blockchain to an existing action associated with a currency value.

3. The method of claim 1, further comprising:
identifying a bet on a second pool, wherein the existing action is an action of the bet and the bet is placed on a majority outcome of at least one majority outcome of the second pool;
identifying the user associated with the bet;
assigning at least one voting partition of a first plurality of pools for real-world events to the user, wherein the first plurality of pools is a subset of a second plurality of pools for real-world events and wherein the first plurality of pools includes the first pool; and
assigning at least one vote, including the vote, to the user that can be placed on a pool of the first plurality of pools.

4. The method of claim 1, further comprising:
identifying a majority outcome of a second pool as a no-contest outcome wherein the existing action is an action of a bet on the second pool;
identifying the bet;
identifying the user associated with the bet;
assigning at least one voting partition of a first plurality of pools for real-world events to the user, wherein the first plurality of pools is a subset of a second plurality of pools for real-world events and wherein the first plurality of pools includes the first pool; and
assigning at least one vote, including the vote, to the user that can be placed on a pool of the first plurality of pools.

5. The method of claim 1, wherein the existing action is an action of a bet on a second pool and the bet is a winning bet placed on a majority outcome of at least one majority outcome of the second pool, the method further comprising in response to determining that the vote is placed on the majority outcome of the first pool calculating the currency payout for the vote on the first pool based on a plurality of bets made on the second pool, including the bet.

6. The method of claim 5, further comprising assigning forfeit currency of at least one bet on the second pool linked on the blockchain to a vote placed against a majority outcome of a third pool for a real-world event to a master user.

7. The method of claim 1, wherein the existing action is an action of a bet on a second pool and a majority outcome of the second pool is a no-contest outcome, the method further comprising assigning a currency amount of the bet on the second pool as the currency payout for the vote on the first pool in response to determining that the vote is placed on the majority outcome of the first pool.

8. The method of claim 1, wherein the existing action comprises one of a bet on a second pool for a real-world event, a transaction to the user, or a reward to the user as a pool creator user.

9. A method for implementing trusted real-world event outcomes on a blockchain, comprising:
generating a first pool for a real-world event including a plurality of potential outcomes for the real-world event;
generating a bet on the first pool including a first potential outcome of the plurality of potential outcomes;
publishing the bet to the blockchain linked to the first pool;
generating a vote on a second pool for a real-world event including a second potential outcome of a plurality of potential outcomes included on the second pool;
publishing the vote to the blockchain linked to the bet; and
determining a currency payout based at least in part on a currency amount of the bet to a user associated with the vote.

10. The method of claim 9, wherein generating the vote on the second pool comprises generating the vote on the second pool in response to the first potential outcome being a majority outcome of at least one majority outcome of the first pool.

11. The method of claim 9, wherein generating the vote on the second pool comprises generating the vote on the second pool in response to a majority outcome of the first pool being a non-contest outcome.

12. The method of claim 9, wherein determining the currency payout comprises determining the currency payout in response to the second potential outcome being a majority outcome of at least one majority outcome of the second pool.

13. The method of claim 9, further comprising assigning a currency fee to a pool creator user associated with the first pool in response to at least one of the plurality of potential outcomes for the real-world event being at least one majority outcome of the first pool.

14. The method of claim 9, further comprising assigning a currency reward to a pool creator user associated with the first pool in response to at least one of the plurality of potential outcomes for the real-world event being at least one majority outcome of the first pool.

15. The method of claim 9, further comprising assigning currency associated with the vote to a master user in response to all majority outcomes of the second pool being at least one potential outcome of the plurality of potential outcomes included on the second pool other than the second potential outcome.

16. The method of claim 9, wherein the plurality of potential outcomes for the event include at least one non-binary outcome.

17. A computing device, comprising a processing device configured with processing device-executable instructions to perform operations comprising:
placing a vote on an outcome of a first pool for a real-world event, wherein the vote is linked on a blockchain to an existing action associated with a currency value;
determining whether the vote is placed on a majority outcome of at least one majority outcome of the first pool; and
determining a currency payout for the vote to a user in response to determining that the vote is placed on the majority outcome of the first pool.

18. The computing device of claim 17, wherein the processing device is configured with processing device-executable instructions to perform operations further comprising identifying the majority outcome from a plurality of outcomes of the first pool based on a plurality of votes, including the vote, placed on the plurality of outcomes, wherein each of the plurality of votes is linked on the blockchain to an existing action associated with a currency value.

19. The computing device of claim 17, wherein the processing device is configured with processing device-executable instructions to perform operations further comprising:
identifying a bet on a second pool, wherein the existing action is an action of the bet and the bet is placed on a majority outcome of at least one majority outcome of the second pool;
identifying the user associated with the bet;
assigning at least one voting partition of a first plurality of pools for real-world events to the user, wherein the first plurality of pools is a subset of a second plurality of pools for real-world events and wherein the first plurality of pools includes the first pool; and
assigning at least one vote, including the vote, to the user that can be placed on a pool of the first plurality of pools.

20. The computing device of claim 17, wherein the processing device is configured with processing device-executable instructions to perform operations further comprising:
identifying a majority outcome of a second pool as a no-contest outcome wherein the existing action is an action of a bet on the second pool;
identifying the bet;
identifying the user associated with the bet;
assigning at least one voting partition of a first plurality of pools for real-world events to the user, wherein the first plurality of pools is a subset of a second plurality of pools for real-world events and wherein the first plurality of pools includes the first pool; and
assigning at least one vote, including the vote, to the user that can be placed on a pool of the first plurality of pools.

21. The computing device of claim 17, wherein the existing action is an action of a bet on a second pool and the bet is a winning bet placed on a majority outcome of at least one majority outcome of the second pool, and wherein the processing device is configured with processing device-executable instructions to perform operations further comprising in response to determining that the vote is placed on the majority outcome of the first pool calculating the currency payout for the vote on the first pool based on a plurality of bets made on the second pool, including the bet.

22. The computing device of claim 21, wherein the processing device is configured with processing device-executable instructions to perform operations further comprising assigning forfeit currency of at least one bet on the second pool linked on the blockchain to a vote placed against a majority outcome of a third pool for a real-world event to a master user.

23. The computing device of claim 17, wherein the existing action is an action of a bet on a second pool and a majority outcome of the second pool is a no-contest outcome, and wherein the processing device is configured with processing device-executable instructions to perform operations further comprising assigning a currency amount of the bet on the second pool as the currency payout for the vote on the first pool in response to determining that the vote is placed on the majority outcome of the first pool.

24. The computing device of claim 17, wherein the existing action comprises one of a bet on a second pool for a real-world event, a transaction to the user, or a reward to the user as a pool creator user.

25. A computing device, comprising a processing device configured with processing device-executable instructions to perform operations comprising:
generating a first pool for a real-world event including a plurality of potential outcomes for the real-world event;
generating a bet on the first pool including a first potential outcome of the plurality of potential outcomes;
publishing the bet to a blockchain linked to the first pool;
generating a vote on a second pool for a real-world event including a second potential outcome of a plurality of potential outcomes included on the second pool;
publishing the vote to the blockchain linked to the bet; and
determining a currency payout based at least in part on a currency amount of the bet to a user associated with the vote.

26. The computing device of claim 25, wherein the processing device is configured with processing device-executable instructions to perform operations such that generating the vote on the second pool comprises generating the vote on the second pool in response to the first potential outcome being a majority outcome of at least one majority outcome of the first pool.

27. The computing device of claim 25, wherein the processing device is configured with processing device-executable instructions to perform operations such that generating the vote on the second pool comprises generating the vote on the second pool in response to a majority outcome of the first pool being a non-contest outcome.

28. The computing device of claim 25, wherein the processing device is configured with processing device-executable instructions to perform operations such that determining the currency payout comprises determining the currency payout in response to the second potential outcome being a majority outcome of at least one majority outcome of the second pool.

29. The computing device of claim 25, wherein the processing device is configured with processing device-executable instructions to perform operations further comprising assigning a currency fee to a pool creator user associated with the first pool in response to at least one of the plurality of potential outcomes for the real-world event being at least one majority outcome of the first pool.

30. The computing device of claim 25, wherein the processing device is configured with processing device-executable instructions to perform operations further comprising assigning a currency reward to a pool creator user associated with the first pool in response to at least one of the plurality of potential outcomes for the real-world event being at least one majority outcome of the first pool.

31. The computing device of claim 25, wherein the processing device is configured with processing device-executable instructions to perform operations further comprising assigning currency associated with the vote to a master user in response to all majority outcomes of the second pool being at least one potential outcome of the plurality of potential outcomes included on the second pool other than the second potential outcome.

32. The computing device of claim 25, wherein the plurality of potential outcomes for the event include at least one non-binary outcome.

33. A non-transitory, processor-readable medium having stored thereon processor-executable instructions configured to cause a processor of a computing device to perform operations comprising:
placing a vote on an outcome of a first pool for a real-world event, wherein the vote is linked on a blockchain to an existing action associated with a currency value;
determining whether the vote is placed on a majority outcome of at least one majority outcome of the first pool; and
determining a currency payout for the vote to a user in response to determining that the vote is placed on the majority outcome of the first pool.

34. A non-transitory, processor-readable medium having stored thereon processor-executable instructions configured to cause a processor of a computing device to perform operations comprising:
generating a first pool for a real-world event including a plurality of potential outcomes for the real-world event;
generating a bet on the first pool including a first potential outcome of the plurality of potential outcomes;
publishing the bet to a blockchain linked to the first pool;
generating a vote on a second pool for a real-world event including a second potential outcome of a plurality of potential outcomes included on the second pool;
publishing the vote to the blockchain linked to the bet; and
determining a currency payout based at least in part on a currency amount of the bet to a user associated with the vote.
